(19) United States
(12) Patent Application Publication
(10) Pub. No.: US 2025/0063034 A1
(43) Pub. Date: Feb. 20, 2025

(54) Local and Reverse Authentication for Cloud Directory Remote Servers Using a Single Sign on (SSO) Authentication Protocol

(71) Applicant: Citrix Systems, Inc., Fort Lauderdale, FL (US)

(72) Inventors: Hubert Divoux, Parkland, FL (US); Mukund Ingale, Pompano Beach, FL (US); Aaroh Ramesh Gala, Pompano Beach, FL (US)

(21) Appl. No.: 18/235,395

(22) Filed: Aug. 18, 2023

(51) Int. Cl. H04L 9/40; G06F 9/451; H04L 9/08; H04L 67/025

(52) U.S. Cl. CPC H04L 63/0815; G06F 9/452; H04L 9/0825; H04L 67/025; H04L 2463/082

(57) ABSTRACT

Methods and systems for authenticating users for remote desktop sessions are described. A computing system may instantiate an interactive credential provider. The computing system may receive, from a client device, a notification of a remote display protocol connection. The computing system may execute, based on the notification of the remote display protocol connection, by the interactive credential provider, and with a cloud directory authority, a single sign on (SSO) protocol. The computing platform may perform, based on successful execution of the SSO protocol and for the client device, a login to a remote session between the client device and the computing system.

### FIELD

Aspects described herein generally relate to computer networking, remote computer access, virtualization, enterprise mobility management, and hardware and software related thereto. More specifically, one or more aspects described herein include using an interactive credential provider and a single sign on authentication protocol to perform local and reverse client authentication for cloud directory remote servers.

### BACKGROUND

In some instances, cloud directory single sign on (SSO) authentication protocols may allow for implicit authentication to a remote cloud directory-joined server from a client machine. For example, a cloud directory SSO protocol may be designed to provide an SSO experience with a remote display protocol. In some instances, however, there may be certain requirements imposed for performing such a cloud directory authentication. For example, integration with a third party identity provider (IDP) and/or the use of two-factor authentication (2FA) or more generally multi-factor authentication (MFA). Such requirements may prevent explicit authentication to the cloud directory from a remote session on a server.

For example, an end user may be able to launch a remote session on the server, authenticating to the remote session with the corresponding cloud directory SSO authentication protocol. However, they might not be able to subsequently unlock the remote session by providing their user credentials. For example, the remote session may be locked either directly by the end user, or implicitly (e.g., via an idle timeout). For example, the inability to unlock the remote session may be due to the cloud directory authentication being configured to require the use of a biometric device that might only be attached to the client machine. As another example, an end user may be able to launch a remote session on a server without SSO authentication (to the remote session), but they might not be able to subsequently logon explicitly to the remote session (by providing their user credentials).

### SUMMARY

The following presents a simplified summary of various aspects described herein. This summary is not an extensive overview, and is not intended to identify required or critical elements or to delineate the scope of the claims. The following summary merely presents some concepts in a simplified form as an introductory prelude to the more detailed description provided below.

To overcome limitations in the prior art described above, and to overcome other limitations that will be apparent upon reading and understanding the present specification, aspects described herein are directed towards remote server authentication using an SSO authentication protocol and an interactive credential provider. Accordingly, in order to improve the customer experience associated with such remote sessions, it may be important to improve the processes by which authentication (e.g., logon or unlock) is performed for server in the context of a cloud directory SSO protocol.

In one or more illustrative embodiments described herein, a computing system that includes one or more processors and memory may instantiate, at a remote desktop server, an interactive credential provider. The computing system may receive, from a client device, a notification of a remote display protocol connection. The computing system may execute, based on the notification of the remote display protocol connection, by the interactive credential provider, and with a cloud directory authority, a single sign on (SSO) protocol, which may be configured for use between the client device and the remote desktop server. The computing system may perform, based on successful execution of the SSO protocol and for the client device, a login to a remote session between the client device and the remote desktop server.

In one or more examples, the computing system may detect session lock for the remote session. The computing system may instantiate the interactive credential provider. The computing system may receive, by the interactive credential provider, selection of a session unlock interface element. The computing system may execute, based on the selection of the session unlock interface element, by the interactive credential provider, and with the cloud directory authority, the SSO protocol. The computing system may unlock, based on successful execution of the SSO protocol and for the client device, the remote session.

In one or more instances, the computing system may generate, by the interactive credential provider, a public-private keypair, wherein executing, the SSO protocol comprises executing, using the public-private keypair, the SSO protocol. In one or more instances, instantiating the interactive credential provider may generate the public-private keypair, and the public-private keypair may include a Rivest-Shamir-Adleman public-private keypair.

In one or more examples, the notification of the remote display protocol connection may include a username hint for a user of the client device. In one or more examples, the interactive credential provider may generate a session login interface element, and executing the SSO protocol may be in response to receiving selection of the session login interface element.

In one or more instances, executing the SSO protocol may include: 1) creating, by the interactive credential provider, a correlation identifier; 2) requesting, using the correlation identifier, by the interactive credential provider, and from the cloud directory authority, a remote session access token, a pseudo-client cloud directory nonce, and a server cloud directory nonce; 3) receiving, from the cloud directory authority, the remote session access token, the pseudo-client cloud directory nonce, and the server cloud directory nonce; 4) creating, by the interactive credential provider, a remote desktop protocol (RDP) assertion, which may be created based on: a public key of the public-private keypair, a device identifier of the cloud directory authority, the remote session access token, the pseudo-client cloud directory nonce, and the server cloud directory nonce; 5) signing, by the interactive credential provider, the RDP assertion; 6) generating a request, by the interactive credential provider, for a credentials blob from the cloud directory authority, where the request may include the RDP assertion and the correlation identifier; and 7) receiving, from the cloud directory authority, the credentials blob in response to the request.

In one or more examples, the computing system may obtain, by the interactive credential provider, cloud directory credentials for the cloud directory authority, which may provide the remote session access token, the pseudo-client cloud directory nonce, and the server cloud directory nonce in response to validating the cloud directory credentials. In one or more examples, obtaining the cloud directory credentials may include obtaining user credentials from a multi-factor authentication (MFA) device connected to the client device.

In one or more instances, obtaining the cloud directory credentials may include, obtaining, via the remote display protocol connection and using a virtual channel protocol, the cloud directory credentials. In one or more instances, obtaining the cloud directory credentials may include performing a reverse seamless authentication process with the client device, which may include routing, via the remote display protocol connection and to the client device, a request for the cloud directory credentials. In one or more instances, performing the login to the remote session may be based on validation of the credentials blob.

These and additional aspects will be appreciated with the benefit of the disclosures discussed in further detail below.

### BRIEF DESCRIPTION OF THE DRAWINGS

A more complete understanding of aspects described herein and the advantages thereof may be acquired by referring to the following description in consideration of the accompanying drawings, in which like reference numbers indicate like features, and wherein:

FIG. 1 depicts an illustrative computer system architecture that may be used in accordance with one or more illustrative aspects described herein.

FIG. 2 depicts an illustrative remote-access system architecture that may be used in accordance with one or more illustrative aspects described herein.

FIG. 3 depicts an illustrative virtualized system architecture that may be used in accordance with one or more illustrative aspects described herein.

FIG. 4 depicts an illustrative cloud-based system architecture that may be used in accordance with one or more illustrative aspects described herein.

FIGS. 5A-5B depict an illustrative computing environment for remote server authentication using an SSO authentication protocol and an interactive credential provider in accordance with one or more illustrative aspects described herein.

FIGS. 6A-6C depict an illustrative event sequence for executing a cloud directory SSO authentication protocol in accordance with one or more illustrative aspects described herein.

FIGS. 7A, 7B, 7C, 7D, 7E, and 7F depict an illustrative event sequence for remote server authentication using an SSO authentication protocol and an interactive credential provider in accordance with one or more illustrative aspects described herein.

FIG. 8 depicts an illustrative method for remote server authentication using an SSO authentication protocol and an interactive credential provider for a remote desktop session login in accordance with one or more illustrative aspects described herein.

FIG. 9 depicts an illustrative method for remote server authentication using an SSO authentication protocol and an interactive credential provider for a remote desktop session unlock in accordance with one or more illustrative aspects described herein.

FIGS. 10-12 depict illustrative user interfaces for remote server authentication using an SSO authentication protocol and an interactive credential provider in accordance with one or more illustrative aspects described herein.

FIG. 13 depicts an illustrative method for reverse seamless authentication using an SSO authentication protocol and an interactive credential provider for a remote desktop session unlock in accordance with one or more illustrative aspects described herein.

### DETAILED DESCRIPTION

In the following description of the various embodiments, reference is made to the accompanying drawings identified above and which form a part hereof, and in which is shown by way of illustration various embodiments in which aspects described herein may be practiced. It is to be understood that other embodiments may be utilized and structural and functional modifications may be made without departing from the scope described herein. Various aspects are capable of other embodiments and of being practiced or being carried out in various different ways.

As a general introduction to the subject matter described in more detail below, described herein are directed towards local and reverse authentication from a client to remote or local server that provides a cloud-based identity and access management (which may be referred to herein as a “Cloud Directory” or “CD”) through a single sign on (SSO) authentication protocol and an interactive credential provider. Examples of a Cloud Directory include, but are not limited to, Microsoft® Azure® Active Directory®, and/or other cloud-based identity and access management services. Cloud directory SSO authentication protocols, such as Azure AD from the Microsoft Corporation of Redmond, Washington, may allow for implicit authentication to a remote AD-joined server from a client machine. Such protocols may be designed to provide an SSO experience with a remote display protocol such as the Independent Computing Architecture (ICA) protocol developed by Citrix Systems, Inc. of Ft. Lauderdale, Florida; or the Remote Desktop Protocol (RDP) manufactured by the Microsoft Corporation of Redmond, Washington (e.g., via implicit authentication on the server side upon remote session launch).

Requirements may be imposed for doing a cloud directory authentication. For example, the integration with a third party identity provider (IDP) and/or the use of two-factor authentication (2FA) or multi-factor authentication (MFA). Because of these requirements, it might not always be possible to explicitly authenticate to the cloud directory system from a remote session on a server.

For example, an end-user may be able to launch a remote session on a server, authenticating to the remote session with a cloud directory SSO authentication protocol.

However, they might not be able to subsequently unlock the remote session by providing their user credentials, e.g. login credentials including, but not limited to: username, password, 2-factor authentication keys, certificates, biometric data, tokens, and the like. The remote session may be locked either directly by the end-user or implicitly, e.g., via an idle timeout. For example, the inability to unlock the remote session may be due to the cloud directory authentication being configured to require the use of a biometric device that is only attached to the client machine.

As another example, the end-user may be able to launch a remote session on a server without SSO authentication (to the remote session), but they might not be able to subsequently logon explicitly to the remote session (e.g., by providing credentials).

Accordingly, described herein is a solution allowing an end-user to do a cloud directory explicit authentication (logon or unlock) to a remote session on a server by reusing a cloud directory SSO authentication protocol outside the scope of its primary design and adding an interactive credential provider to the server and a reverse authentication client-side component (which may be used only when needed/selected).

The interactive credential provider may allow selection if the authentication is done entirely from the server (when doable) or if it is done in combination with the reverse authentication client-side component. The selection may be done explicitly by the end-user via UI input and/or automatically (e.g., according to a configuration setting, a machine policy, a user policy (from a user identifier such as a username), the parameters of a configured cloud directory authentication, and/or otherwise).

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “mounted,” “connected,” “coupled,” “positioned,” “engaged” and similar terms, is meant to include both direct and indirect mounting, connecting, coupling, positioning and engaging.

### Computing Architecture

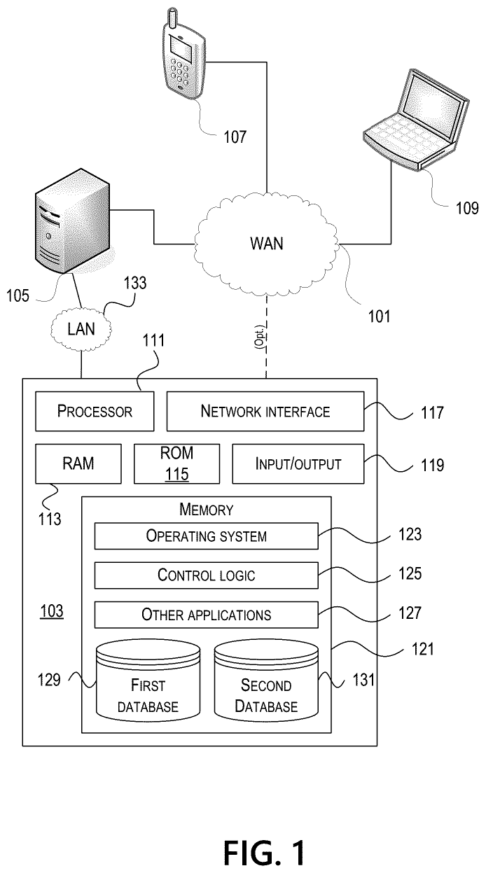

Computer software, hardware, and networks may be utilized in a variety of different system environments, including standalone, networked, remote-access (also known as remote desktop), virtualized, and/or cloud-based environments, among others. FIG. 1 illustrates one example of a system architecture and data processing device that may be used to implement one or more illustrative aspects described herein in a standalone and/or networked environment. Various network nodes 103, 105, 107, and 109 may be interconnected via a wide area network (WAN) 101, such as the Internet. Other networks may also or alternatively be used, including private intranets, corporate networks, local area networks (LAN), metropolitan area networks (MAN), wireless networks, personal networks (PAN), and the like. Network 101 is for illustration purposes and may be replaced with fewer or additional computer networks. A local area network 133 may have one or more of any known LAN topology and may use one or more of a variety of different protocols, such as Ethernet. Devices 103, 105, 107, and 109 and other devices (not shown) may be connected to one or more of the networks via twisted pair wires, coaxial cable, fiber optics, radio waves, or other communication media.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data—attributable to a single entity—which resides across all physical networks.

The components may include data server 103, web server 105, and client computers 107, 109. Data server 103 provides overall access, control and administration of databases and control software for performing one or more illustrative aspects describe herein. Data server 103 may be connected to web server 105 through which users interact with and obtain data as requested. Alternatively, data server 103 may act as a web server itself and be directly connected to the Internet. Data server 103 may be connected to web server 105 through the local area network 133, the wide area network 101 (e.g., the Internet), via direct or indirect connection, or via some other network. Users may interact with the data server 103 using remote computers 107, 109, e.g., using a web browser to connect to the data server 103 via one or more externally exposed web sites hosted by web server 105. Client computers 107, 109 may be used in concert with data server 103 to access data stored therein, or may be used for other purposes. For example, from client device 107 a user may access web server 105 using an Internet browser, as is known in the art, or by executing a software application that communicates with web server 105 and/or data server 103 over a computer network (such as the Internet).

Servers and applications may be combined on the same physical machines, and retain separate virtual or logical addresses, or may reside on separate physical machines. FIG. 1 illustrates just one example of a network architecture that may be used, and those of skill in the art will appreciate that the specific network architecture and data processing devices used may vary, and are secondary to the functionality that they provide, as further described herein. For example, services provided by web server 105 and data server 103 may be combined on a single server.

Each component 103, 105, 107, 109 may be any type of known computer, server, or data processing device. Data server 103, e.g., may include a processor 111 controlling overall operation of the data server 103. Data server 103 may further include random access memory (RAM) 113, read only memory (ROM) 115, network interface 117, input/output interfaces 119 (e.g., keyboard, mouse, display, printer, etc.), and memory 121. Input/output (I/O) 119 may include a variety of interface units and drives for reading, writing, displaying, and/or printing data or files. Memory 121 may further store operating system software 123 for controlling overall operation of the data processing device 103, control logic 125 for instructing data server 103 to perform aspects described herein, and other application software 127 providing secondary, support, and/or other functionality which may or might not be used in conjunction with aspects described herein. The control logic 125 may also be referred to herein as the data server software 125. Functionality of the data server software 125 may refer to operations or decisions made automatically based on rules coded into the control logic 125, made manually by a user providing input into the system, and/or a combination of automatic processing based on user input (e.g., queries, data updates, etc.).

Memory 121 may also store data used in performance of one or more aspects described herein, including a first database 129 and a second database 131. In some embodiments, the first database 129 may include the second database 131 (e.g., as a separate table, report, etc.). That is, the information can be stored in a single database, or separated into different logical, virtual, or physical databases, depending on system design. Devices 105, 107, and 109 may have similar or different architecture as described with respect to device 103. Those of skill in the art will appreciate that the functionality of data processing device 103 (or device 105, 107, or 109) as described herein may be spread across multiple data processing devices, for example, to distribute processing load across multiple computers, to segregate transactions based on geographic location, user access level, quality of service (QOS), etc.

One or more aspects may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HyperText Markup Language (HTML) or Extensible Markup Language (XML). The computer executable instructions may be stored on a non-transitory computer readable medium such as a nonvolatile storage device. Additionally or alternatively, the instructions may be stored in a non-transitory volatile storage device, such as a random-access memory (RAM). The instructions, in whole or in part, may be stored in any one or any combination of suitable computer readable storage media including, but not limited to: hard disks, CD-ROMs, optical storage devices, magnetic storage devices, solid state storage devices, RAM, ROM, and/or any combination thereof. In addition, various transmission (non-storage) media representing data or events as described herein may be transferred between a source and a destination in the form of electromagnetic waves traveling through signal-conducting media such as metal wires, optical fibers, and/or wireless transmission media (e.g., air and/or space). Various aspects described herein may be embodied as a method, a data processing system, or a computer program product. Therefore, various functionalities may be embodied in whole or in part in software, firmware, and/or hardware or hardware equivalents such as integrated circuits, field programmable gate arrays (FPGA), and the like. Particular data structures may be used to more effectively implement one or more aspects described herein, and such data structures are contemplated within the scope of computer executable instructions and computer-usable data described herein.

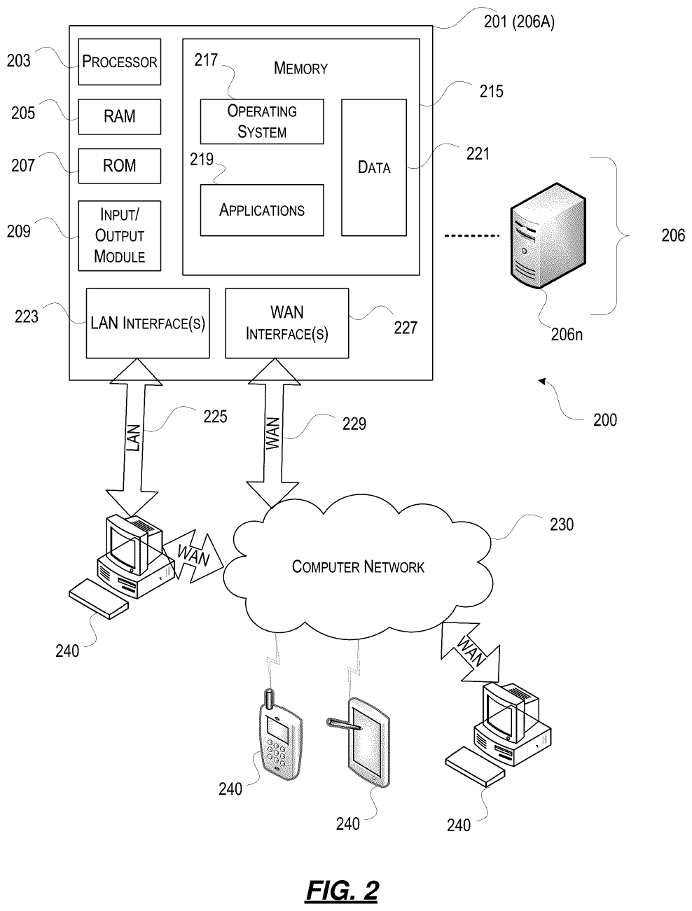

With further reference to FIG. 2, one or more aspects described herein may be implemented in a remote-access environment. FIG. 2 depicts an example system architecture including a computing device 201 in an illustrative computing environment 200 that may be used according to one or more illustrative aspects described herein. Computing device 201 may be used as a server 206a in a single-server or multi-server desktop virtualization system (e.g., a remote access or cloud system) and can be configured to provide virtual machines for client access devices. The computing device 201 may have a processor 203 for controlling overall operation of the device 201 and its associated components, including RAM 205, ROM 207, Input/Output (I/O) module 209, and memory 215.

I/O module 209 may include a mouse, keypad, touch screen, scanner, optical reader, and/or stylus (or other input device(s)) through which a user of computing device 201 may provide input, and may also include one or more of a speaker for providing audio output and one or more of a video display device for providing textual, audiovisual, and/or graphical output. Software may be stored within memory 215 and/or other storage to provide instructions to processor 203 for configuring computing device 201 into a special purpose computing device in order to perform various functions as described herein. For example, memory 215 may store software used by the computing device 201, such as an operating system 217, application programs 219, and an associated database 221.

Computing device 201 may operate in a networked environment supporting connections to one or more remote computers, such as terminals 240 (also referred to as client devices and/or client machines). The terminals 240 may be personal computers, mobile devices, laptop computers, tablets, or servers that include many or all of the elements described above with respect to the computing device 103 or 201. The network connections depicted in FIG. 2 include a local area network (LAN) 225 and a wide area network (WAN) 229, but may also include other networks. When used in a LAN networking environment, computing device 201 may be connected to the LAN 225 through a network interface or adapter 223. When used in a WAN networking environment, computing device 201 may include a modem or other wide area network interface 227 for establishing communications over the WAN 229, such as computer network 230 (e.g., the Internet). It will be appreciated that the network connections shown are illustrative and other means of establishing a communications link between the computers may be used. Computing device 201 and/or terminals 240 may also be mobile terminals (e.g., mobile phones, smartphones, personal digital assistants (PDAs), notebooks, etc.) including various other components, such as a battery, speaker, and antennas (not shown).

Aspects described herein may also be operational with numerous other general purpose or special purpose computing system environments or configurations. Examples of other computing systems, environments, and/or configurations that may be suitable for use with aspects described herein include, but are not limited to, personal computers, server computers, hand-held or laptop devices, multiprocessor systems, microprocessor-based systems, set top boxes, programmable consumer electronics, network personal computers (PCs), minicomputers, mainframe computers, distributed computing environments that include any of the above systems or devices, and the like.

As shown in FIG. 2, one or more client devices 240 may be in communication with one or more servers 206a-206n (generally referred to herein as “server(s) 206”). In one embodiment, the computing environment 200 may include a network appliance installed between the server(s) 206 and client machine(s) 240. The network appliance may manage client/server connections, and in some cases can load balance client connections amongst a plurality of backend servers 206.

The client machine(s) 240 may in some embodiments be referred to as a single client machine 240 or a single group of client machines 240, while server(s) 206 may be referred to as a single server 206 or a single group of servers 206. In one embodiment a single client machine 240 communicates with more than one server 206, while in another embodiment a single server 206 communicates with more than one client machine 240. In yet another embodiment, a single client machine 240 communicates with a single server 206.

A client machine 240 can, in some embodiments, be referenced by any one of the following non-exhaustive terms: client machine(s); client(s); client computer(s); client device(s); client computing device(s); local machine; remote machine; client node(s); endpoint(s); or endpoint node(s). The server 206, in some embodiments, may be referenced by any one of the following non-exhaustive terms: server(s), local machine; remote machine; server farm(s), or host computing device(s).

In one embodiment, the client machine 240 may be a virtual machine. The virtual machine may be any virtual machine, while in some embodiments the virtual machine may be any virtual machine managed by a Type 1 or Type 2 hypervisor, for example, a hypervisor developed by Citrix Systems, IBM, VMware, or any other hypervisor. In some aspects, the virtual machine may be managed by a hypervisor, while in other aspects the virtual machine may be managed by a hypervisor executing on a server 206 or a hypervisor executing on a client 240.

Some embodiments include a client device 240 that displays application output generated by an application remotely executing on a server 206 or other remotely located machine. In these embodiments, the client device 240 may execute a virtual machine receiver program or application to display the output in an application window, a browser, or other output window. In one example, the application is a desktop, while in other examples the application is an application that generates or presents a desktop. A desktop may include a graphical shell providing a user interface for an instance of an operating system in which local and/or remote applications can be integrated. Applications, as used herein, are programs that execute after an instance of an operating system (and, optionally, also the desktop) has been loaded.

The server 206, in some embodiments, uses a remote presentation protocol or other program to send data to a thin-client or remote-display application executing on the client to present display output generated by an application executing on the server 206. The thin-client or remote-display protocol can be any one of the following non-exhaustive list of protocols: the Independent Computing Architecture (ICA) protocol developed by Citrix Systems, Inc. of Ft. Lauderdale, Florida; or the Remote Desktop Protocol (RDP) manufactured by the Microsoft Corporation of Redmond, Washington.

A remote computing environment may include more than one server 206a-206n such that the servers 206a-206n are logically grouped together into a server farm 206, for example, in a cloud computing environment. The server farm 206 may include servers 206 that are geographically dispersed while logically grouped together, or servers 206 that are located proximate to each other while logically grouped together. Geographically dispersed servers 206a-206n within a server farm 206 can, in some embodiments, communicate using a WAN (wide), MAN (metropolitan), or LAN (local), where different geographic regions can be characterized as: different continents; different regions of a continent; different countries; different states; different cities; different campuses; different rooms; or any combination of the preceding geographical locations. In some embodiments the server farm 206 may be administered as a single entity, while in other embodiments the server farm 206 can include multiple server farms.

In some embodiments, a server farm may include servers 206 that execute a substantially similar type of operating system platform (e.g., WINDOWS, UNIX, LINUX, iOS, ANDROID, etc.) In other embodiments, server farm 206 may include a first group of one or more servers that execute a first type of operating system platform, and a second group of one or more servers that execute a second type of operating system platform.

Server 206 may be configured as any type of server, as needed, e.g., a file server, an application server, a web server, a proxy server, an appliance, a network appliance, a gateway, an application gateway, a gateway server, a virtualization server, a deployment server, a Secure Sockets Layer (SSL) VPN server, a firewall, a web server, an application server or as a master application server, a server executing an cloud directory, or a server executing an application acceleration program that provides firewall functionality, application functionality, or load balancing functionality. Other server types may also be used.

Some embodiments include a first server 206a that receives requests from a client machine 240, forwards the request to a second server 206b (not shown), and responds to the request generated by the client machine 240 with a response from the second server 206b (not shown.) First server 206a may acquire an enumeration of applications available to the client machine 240 as well as address information associated with an application server 206 hosting an application identified within the enumeration of applications. First server 206a can then present a response to the client's request using a web interface, and communicate directly with the client 240 to provide the client 240 with access to an identified application. One or more clients 240 and/or one or more servers 206 may transmit data over network 230, e.g., network 101.

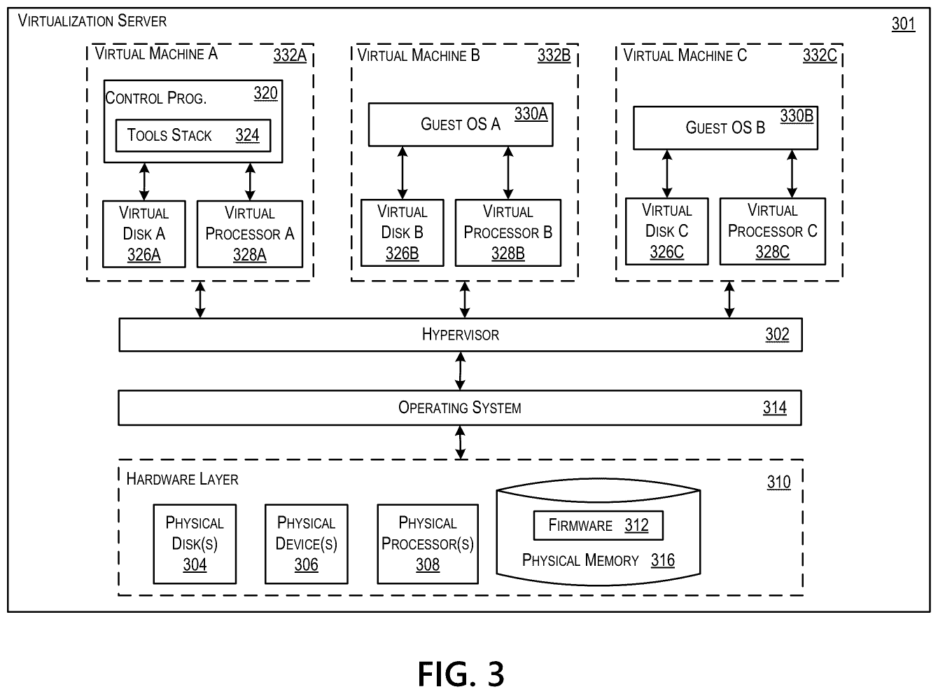

FIG. 3 shows a high-level architecture of an illustrative desktop virtualization system. As shown, the desktop virtualization system may be single-server or multi-server system, or cloud system, including at least one virtualization server 301 configured to provide virtual desktops and/or virtual applications to one or more client access devices 240. As used herein, a desktop refers to a graphical environment or space in which one or more applications may be hosted and/or executed. A desktop may include a graphical shell providing a user interface for an instance of an operating system in which local and/or remote applications can be integrated. Applications may include programs that execute after an instance of an operating system (and, optionally, also the desktop) has been loaded. Each instance of the operating system may be physical (e.g., one operating system per device) or virtual (e.g., many instances of an OS running on a single device). Each application may be executed on a local device, or executed on a remotely located device (e.g., remoted).

A computer device 301 may be configured as a virtualization server in a virtualization environment, for example, a single-server, multi-server, or cloud computing environment. Virtualization server 301 illustrated in FIG. 3 can be deployed as and/or implemented by one or more embodiments of the server 206 illustrated in FIG. 2 or by other known computing devices. Included in virtualization server 301 is a hardware layer that can include one or more physical disks 304, one or more physical devices 306, one or more physical processors 308, and one or more physical memories 316. In some embodiments, firmware 312 can be stored within a memory element in the physical memory 316 and can be executed by one or more of the physical processors 308. Virtualization server 301 may further include an operating system 314 that may be stored in a memory element in the physical memory 316 and executed by one or more of the physical processors 308. Still further, a hypervisor 302 may be stored in a memory element in the physical memory 316 and can be executed by one or more of the physical processors 308.

Executing on one or more of the physical processors 308 may be one or more virtual machines 332A-C(generally 332). Each virtual machine 332 may have a virtual disk 326A-C and a virtual processor 328A-C. In some embodiments, a first virtual machine 332A may execute, using a virtual processor 328A, a control program 320 that includes a tools stack 324. Control program 320 may be referred to as a control virtual machine, Dom0, Domain 0, or other virtual machine used for system administration and/or control. In some embodiments, one or more virtual machines 332B-C can execute, using a virtual processor 328B-C, a guest operating system 330A-B.

Virtualization server 301 may include a hardware layer 310 with one or more pieces of hardware that communicate with the virtualization server 301. In some embodiments, the hardware layer 310 can include one or more physical disks 304, one or more physical devices 306, one or more physical processors 308, and one or more physical memory 316. Physical components 304, 306, 308, and 316 may include, for example, any of the components described above. Physical devices 306 may include, for example, a network interface card, a video card, a keyboard, a mouse, an input device, a monitor, a display device, speakers, an optical drive, a storage device, a universal serial bus connection, a printer, a scanner, a network element (e.g., router, firewall, network address translator, load balancer, virtual private network (VPN) gateway, Dynamic Host Configuration Protocol (DHCP) router, etc.), or any device connected to or communicating with virtualization server 301. Physical memory 316 in the hardware layer 310 may include any type of memory. Physical memory 316 may store data, and in some embodiments may store one or more programs, or set of executable instructions. FIG. 3 illustrates an embodiment where firmware 312 is stored within the physical memory 316 of virtualization server 301. Programs or executable instructions stored in the physical memory 316 can be executed by the one or more processors 308 of virtualization server 301.

Virtualization server 301 may also include a hypervisor 302. In some embodiments, hypervisor 302 may be a program executed by processors 308 on virtualization server 301 to create and manage any number of virtual machines 332. Hypervisor 302 may be referred to as a virtual machine monitor, or platform virtualization software. In some embodiments, hypervisor 302 can be any combination of executable instructions and hardware that monitors virtual machines executing on a computing machine. Hypervisor 302 may be Type 2 hypervisor, where the hypervisor executes within an operating system 314 executing on the virtualization server 301. Virtual machines may then execute at a level above the hypervisor 302. In some embodiments, the Type 2 hypervisor may execute within the context of a user's operating system such that the Type 2 hypervisor interacts with the user's operating system. In other embodiments, one or more virtualization servers 301 in a virtualization environment may instead include a Type 1 hypervisor (not shown). A Type 1 hypervisor may execute on the virtualization server 301 by directly accessing the hardware and resources within the hardware layer 310. That is, while a Type 2 hypervisor 302 accesses system resources through a host operating system 314, as shown, a Type 1 hypervisor may directly access all system resources without the host operating system 314. A Type 1 hypervisor may execute directly on one or more physical processors 308 of virtualization server 301, and may include program data stored in the physical memory 316.

Hypervisor 302, in some embodiments, can provide virtual resources to operating systems 330 or control programs 320 executing on virtual machines 332 in any manner that simulates the operating systems 330 or control programs 320 having direct access to system resources. System resources can include, but are not limited to, physical devices 306, physical disks 304, physical processors 308, physical memory 316, and any other component included in hardware layer 310 of the virtualization server 301. Hypervisor 302 may be used to emulate virtual hardware, partition physical hardware, virtualize physical hardware, and/or execute virtual machines that provide access to computing environments. In still other embodiments, hypervisor 302 may control processor scheduling and memory partitioning for a virtual machine 332 executing on virtualization server 301. Hypervisor 302 may include those manufactured by VMWare, Inc., of Palo Alto, California; HyperV, VirtualServer or virtual PC hypervisors provided by Microsoft, or others. In some embodiments, virtualization server 301 may execute a hypervisor 302 that creates a virtual machine platform on which guest operating systems may execute. In these embodiments, the virtualization server 301 may be referred to as a host server. An example of such a virtualization server is the Citrix Hypervisor provided by Citrix Systems, Inc., of Fort Lauderdale, FL.

Hypervisor 302 may create one or more virtual machines 332B-C(generally 332) in which guest operating systems 330 execute. In some embodiments, hypervisor 302 may load a virtual machine image to create a virtual machine 332. In other embodiments, the hypervisor 302 may execute a guest operating system 330 within virtual machine 332. In still other embodiments, virtual machine 332 may execute guest operating system 330.

In addition to creating virtual machines 332, hypervisor 302 may control the execution of at least one virtual machine 332. In other embodiments, hypervisor 302 may present at least one virtual machine 332 with an abstraction of at least one hardware resource provided by the virtualization server 301 (e.g., any hardware resource available within the hardware layer 310). In other embodiments, hypervisor 302 may control the manner in which virtual machines 332 access physical processors 308 available in virtualization server 301. Controlling access to physical processors 308 may include determining whether a virtual machine 332 should have access to a processor 308, and how physical processor capabilities are presented to the virtual machine 332.

As shown in FIG. 3, virtualization server 301 may host or execute one or more virtual machines 332. A virtual machine 332 is a set of executable instructions that, when executed by a processor 308, may imitate the operation of a physical computer such that the virtual machine 332 can execute programs and processes much like a physical computing device. While FIG. 3 illustrates an embodiment where a virtualization server 301 hosts three virtual machines 332, in other embodiments virtualization server 301 can host any number of virtual machines 332. Hypervisor 302, in some embodiments, may provide each virtual machine 332 with a unique virtual view of the physical hardware, memory, processor, and other system resources available to that virtual machine 332. In some embodiments, the unique virtual view can be based on one or more of virtual machine permissions, application of a policy engine to one or more virtual machine identifiers, a user accessing a virtual machine, the applications executing on a virtual machine, networks accessed by a virtual machine, or any other desired criteria. For instance, hypervisor 302 may create one or more unsecure virtual machines 332 and one or more secure virtual machines 332. Unsecure virtual machines 332 may be prevented from accessing resources, hardware, memory locations, and programs that secure virtual machines 332 may be permitted to access. In other embodiments, hypervisor 302 may provide each virtual machine 332 with a substantially similar virtual view of the physical hardware, memory, processor, and other system resources available to the virtual machines 332.

Each virtual machine 332 may include a virtual disk 326A-C(generally 326) and a virtual processor 328A-C(generally 328.) The virtual disk 326, in some embodiments, is a virtualized view of one or more physical disks 304 of the virtualization server 301, or a portion of one or more physical disks 304 of the virtualization server 301. The virtualized view of the physical disks 304 can be generated, provided, and managed by the hypervisor 302. In some embodiments, hypervisor 302 provides each virtual machine 332 with a unique view of the physical disks 304. Thus, in these embodiments, the particular virtual disk 326 included in each virtual machine 332 can be unique when compared with the other virtual disks 326.

A virtual processor 328 can be a virtualized view of one or more physical processors 308 of the virtualization server 301. In some embodiments, the virtualized view of the physical processors 308 can be generated, provided, and managed by hypervisor 302. In some embodiments, virtual processor 328 has substantially all of the same characteristics of at least one physical processor 308. In other embodiments, virtual processor 308 provides a modified view of physical processors 308 such that at least some of the characteristics of the virtual processor 328 are different than the characteristics of the corresponding physical processor 308.

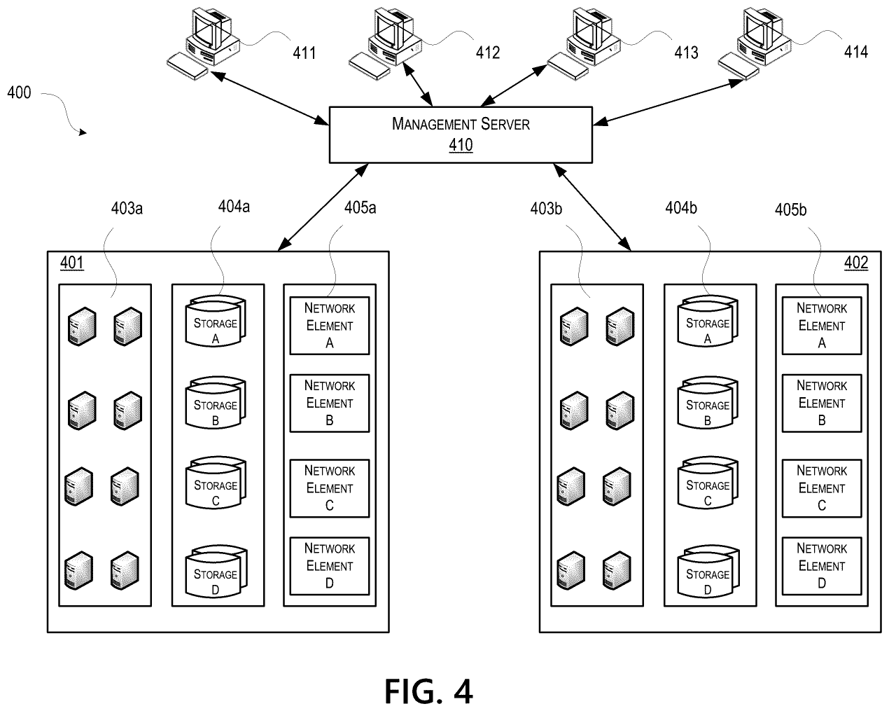

With further reference to FIG. 4, some aspects described herein may be implemented in a cloud-based environment. FIG. 4 illustrates an example of a cloud computing environment (or cloud system) 400. As seen in FIG. 4, client computers 411-414 may communicate with a cloud management server 410 to access the computing resources (e.g., host servers 403a-403b (generally referred herein as “host servers 403”), storage resources 404a-404b (generally referred herein as “storage resources 404”), and network elements 405a-405b (generally referred herein as “network resources 405”)) of the cloud system.

Management server 410 may be implemented on one or more physical servers. The management server 410 may run, for example, Citrix Cloud by Citrix Systems, Inc. of Ft. Lauderdale, FL, or OPENSTACK, among others. Management server 410 may manage various computing resources, including cloud hardware and software resources, for example, host computers 403, data storage devices 404, and networking devices 405. The cloud hardware and software resources may include private and/or public components. For example, a cloud may be configured as a private cloud to be used by one or more particular customers or client computers 411-414 and/or over a private network. In other embodiments, public clouds or hybrid public-private clouds may be used by other customers over an open or hybrid networks.

Management server 410 may be configured to provide user interfaces through which cloud operators and cloud customers may interact with the cloud system 400. For example, the management server 410 may provide a set of application programming interfaces (APIs) and/or one or more cloud operator console applications (e.g., web-based or standalone applications) with user interfaces to allow cloud operators to manage the cloud resources, configure the virtualization layer, manage customer accounts, and perform other cloud administration tasks. The management server 410 also may include a set of APIs and/or one or more customer console applications with user interfaces configured to receive cloud computing requests from end users via client computers 411-414, for example, requests to create, modify, or destroy virtual machines within the cloud. Client computers 411-414 may connect to management server 410 via the Internet or some other communication network, and may request access to one or more of the computing resources managed by management server 410. In response to client requests, the management server 410 may include a resource manager configured to select and provision physical resources in the hardware layer of the cloud system based on the client requests. For example, the management server 410 and additional components of the cloud system may be configured to provision, create, and manage virtual machines and their operating environments (e.g., hypervisors, storage resources, services offered by the network elements, etc.) for customers at client computers 411-414, over a network (e.g., the Internet), providing customers with computational resources, data storage services, networking capabilities, and computer platform and application support. Cloud systems also may be configured to provide various specific services, including security systems, development environments, user interfaces, and the like.

Certain clients 411-414 may be related, for example, to different client computers creating virtual machines on behalf of the same end user, or different users affiliated with the same company or organization. In other examples, certain clients 411-414 may be unrelated, such as users affiliated with different companies or organizations. For unrelated clients, information on the virtual machines or storage of any one user may be hidden from other users.

Referring now to the physical hardware layer of a cloud computing environment, availability zones 401-402 (or zones) may refer to a collocated set of physical computing resources. Zones may be geographically separated from other zones in the overall cloud of computing resources. For example, zone 401 may be a first cloud datacenter located in California, and zone 402 may be a second cloud datacenter located in Florida. Management server 410 may be located at one of the availability zones, or at a separate location. Each zone may include an internal network that interfaces with devices that are outside of the zone, such as the management server 410, through a gateway. End users of the cloud (e.g., clients 411-414) might or might not be aware of the distinctions between zones. For example, an end user may request the creation of a virtual machine having a specified amount of memory, processing power, and network capabilities. The management server 410 may respond to the user's request and may allocate the resources to create the virtual machine without the user knowing whether the virtual machine was created using resources from zone 401 or zone 402. In other examples, the cloud system may allow end users to request that virtual machines (or other cloud resources) are allocated in a specific zone or on specific resources 403-405 within a zone.

In this example, each zone 401-402 may include an arrangement of various physical hardware components (or computing resources) 403-405, for example, physical hosting resources (or processing resources), physical network resources, physical storage resources, switches, and additional hardware resources that may be used to provide cloud computing services to customers. The physical hosting resources in a cloud zone 401-402 may include one or more computer servers 403, such as the virtualization servers 301 described above, which may be configured to create and host virtual machine instances. The physical network resources in a cloud zone 401 or 402 may include one or more network elements 405 (e.g., network service providers) comprising hardware and/or software configured to provide a network service to cloud customers, such as firewalls, network address translators, load balancers, virtual private network (VPN) gateways, Dynamic Host Configuration Protocol (DHCP) routers, and the like. The storage resources in the cloud zone 401-402 may include storage disks (e.g., solid state drives (SSDs), magnetic hard disks, etc.) and other storage devices.

The example cloud computing environment shown in FIG. 4 also may include a virtualization layer (e.g., as shown in FIGS. 1-3) with additional hardware and/or software resources configured to create and manage virtual machines and provide other services to customers using the physical resources in the cloud. The virtualization layer may include hypervisors, as described above in FIG. 3, along with other components to provide network virtualizations, storage virtualizations, etc. The virtualization layer may be as a separate layer from the physical resource layer, or may share some or all of the same hardware and/or software resources with the physical resource layer. For example, the virtualization layer may include a hypervisor installed in each of the virtualization servers 403 with the physical computing resources. Known cloud systems may alternatively be used, e.g., WINDOWS AZURE (Microsoft Corporation of Redmond Washington), AMAZON EC2 (Amazon.com Inc. of Seattle, Washington), IBM BLUE CLOUD (IBM Corporation of Armonk, New York), or others.

### Local and Reverse Authentication for Cloud Directory Remote Servers Using a Single Sign on (SSO) Authentication Protocol

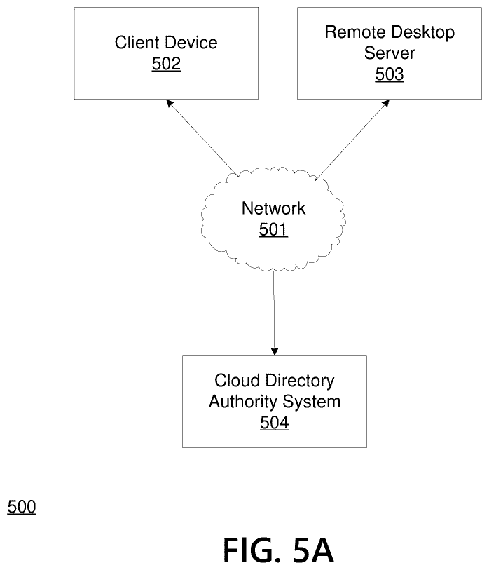

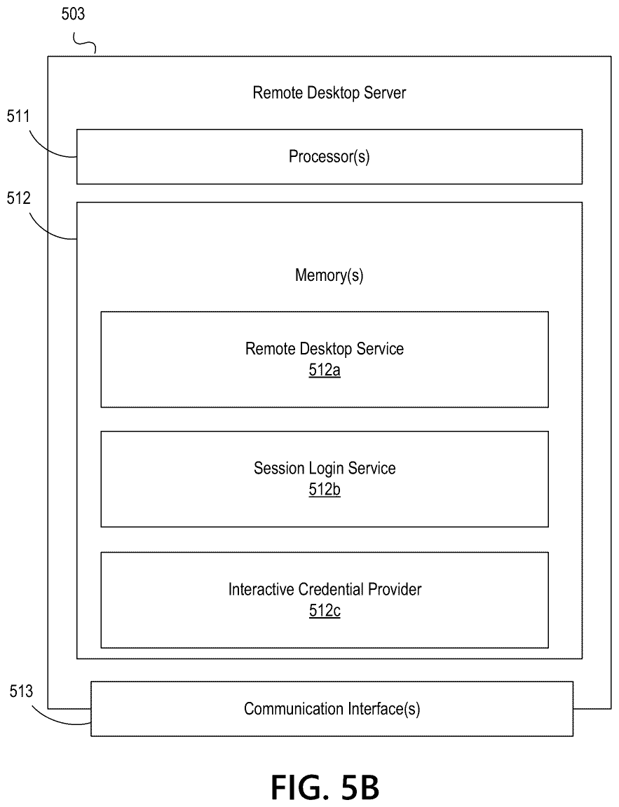

FIGS. 5A-5B depict an illustrative computing environment for remote server authentication using an SSO authentication protocol and an interactive credential provider in accordance with one or more example embodiments. Referring to FIG. 5A, computing environment 500 may include one or more computer systems. For example, computing environment 500 may include client device 502, remote desktop server 503, and cloud directory authority system 504.

Client device 502 (which may, e.g., be a computing device similar to devices 107 or 109, shown in FIG. 1, or client machine 240, shown in FIG. 2) may include one or more computing devices configured to perform one or more of the functions described herein. For example, client device 502 may be a laptop computer, desktop computer, mobile device, a tablet, a smart phone, and/or other device configured to establish a remote desktop session. In some instances, the client device 502 may be configured with a multi-factor authentication (MFA) device, for use in authenticating to the remote desktop session. In some instances, the client device 502 may be configured to display one or more graphical user interfaces (e.g., login interfaces, unlock interfaces or the like). Although a single client device is shown, this is for illustrative purposes only. Any number of client devices may be implemented without departing from the scope of the disclosure.

Remote desktop server 503 (which may be similar to web server 105 or data server 103, shown in FIG. 1, computing device 201 or server 206, shown in FIG. 2, and/or virtualization server 301, as shown in FIG. 3,) may be configured to host and/or otherwise authenticate users to remote desktop sessions. As described further below, the remote desktop server 503 may be configured with a session login service and an interactive credential provider, which may be used to authenticate a user to initiate and/or unlock a remote desktop session. In some instances, the remote desktop server 503 may be configured to authenticate users using cloud directory resources.

Cloud directory authority system 504 (which may be similar to server 206 (shown in FIG. 2), and/or other systems, may be configured to provide authentication services to the remote desktop server 503 (e.g., for the purpose of establishing and/or unlocking remote desktop sessions). In some instances, the cloud directory authority system 504 may support a single sign on (SSO) protocol.

Computing environment 500 may also include one or more networks, which may interconnect client device 502, remote desktop server 503, and cloud directory authority system 504. For example, computing environment 500 may include a network 501 (which may e.g., interconnect client device 502, remote desktop server 503, and cloud directory authority system 504). In some instances, the network 501 may be similar to computer network 230, which is shown in FIG. 2.

In one or more arrangements, client device 502, remote desktop server 503, cloud directory authority system 504 and/or the other systems included in computing environment 500 may be any type of computing device capable of supporting remote desktop services and/or authentication to such services through an SSO protocol. For example, client device 502, remote desktop server 503, cloud directory authority system 504, and/or the other systems included in computing environment 500 may in some instances, be and/or include server computers, desktop computers, laptop computers, tablet computers, smart phones, or the like that may include one or more processors, memories, communication interfaces, storage devices, and/or other components. As noted above, and as illustrated in greater detail below, any and/or all of client device 502, remote desktop server 503, and cloud directory authority system 504 may, in some instances, be special purpose computing devices configured to perform specific functions.

Referring to FIG. 5B, remote desktop server 503 may include one or more processors 511, memory 512, and communication interface 513. A data bus may interconnect processor 511, memory 512, and communication interface 513. Communication interface 513 may be a network interface configured to support communication between remote desktop server 503 and one or more networks (e.g., network 501, or the like). Memory 512 may include one or more program modules having instructions that when executed by processor 511 may cause remote desktop server 503 to perform one or more functions described herein and/or access one or more databases that may store and/or otherwise maintain information which may be used by such program modules and/or processor 511. In some instances, the one or more program modules and/or databases may be stored by and/or maintained in different memory units of remote desktop server 503. For example, remote desktop server 503 may have, host, store, and/or include a remote desktop service 512a, a session login service 512b, and interactive credential provider 512c.

Remote desktop service 512a may store instructions that may support the ability of the remote desktop server 503 to host and/or otherwise provide remote desktop services.

Session login service 512b may provide and/or otherwise support user interfaces that may enable explicit (e.g., in contrast to SSO) login and/or unlock functionality for remote desktops or local desktops. Interactive credential provider 512c may be a component object model (COM) component, configured to communicate with the session login service 512b (e.g., for providing credentials, or the like to enable the session login service 512b to communicate with the cloud directory authority system 504).

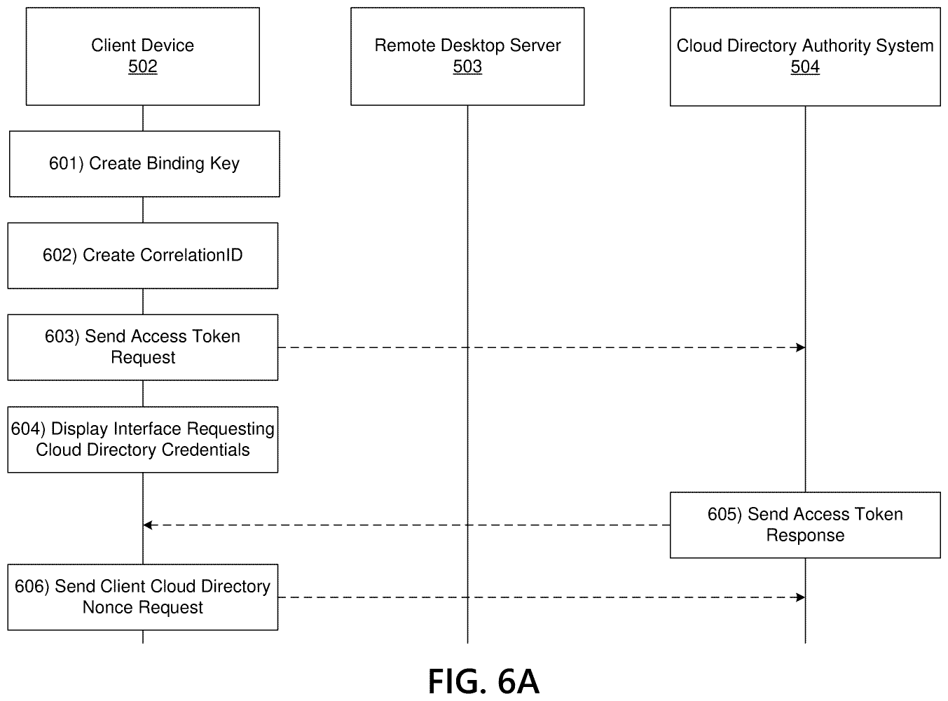

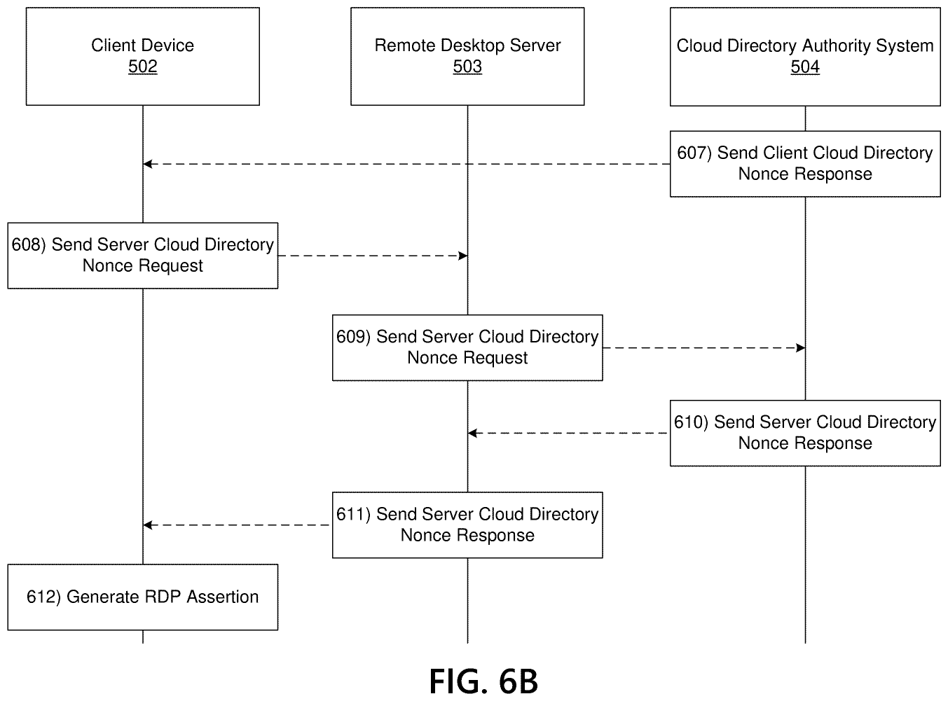

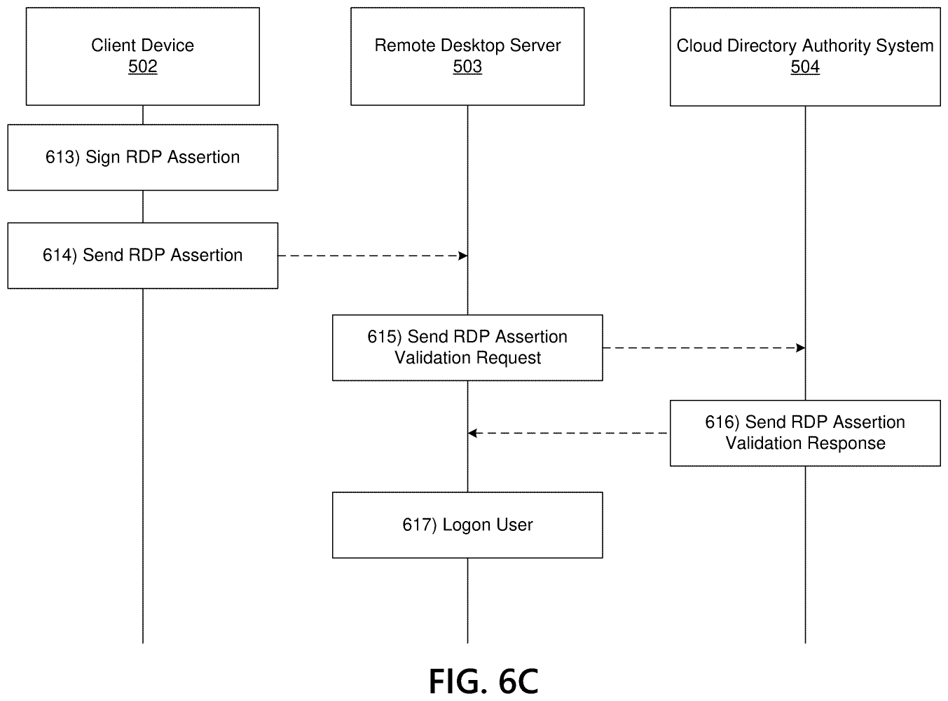

FIGS. 6A-6C depict an illustrative event sequence for an cloud directory SSO authentication protocol in accordance with one or more example embodiments. It should be understood that steps 601-617 may, in some instances, occur in the order as shown with regard to FIGS. 6A-6C. For example, after completing step 606 of FIG. 6A, the event sequence may proceed to step 607 of FIG. 6B.

Referring to FIG. 6A, at step 601, the client device 502 may create a binding key. For example, the client device 502 may generate a Rivest-Shamir-Adleman (RSA) public/private keypair, which may be used to request an access token (e.g., a remote session access token) from the cloud directory authority system 504, bind remote desktop protocol (RDP) assertions to a user of the client device 502, and/or to perform other actions. In some instances, in generating the binding key, the client device 502 may use biometric information such as a thumbprint and/or other information corresponding to the user.

At step 602, the client device 502 may create a correlation identifier. For example, the client device 502 may generate a unique user identifier that may be used for tracing and/or telemetry of communications between the client device 502 and the remote desktop server 503 and/or the cloud directory authority system 504.

At step 603, the client device 502 may send a request to the cloud directory authority system 504 for an access token (e.g., a remote session access token) for a target machine (e.g., the remote desktop server 503). In some instances, in sending the access token request, the client device 502 may send a device identifier of the cloud directory authority system 504, a username hint for the user, a thumbprint corresponding to the public key of the binding key (e.g., generated at step 601), an identifier of the client device 502, and the correlation identifier (generated at step 602).

At step 604, the client device 502 may display an interface requesting the user's credentials to access the cloud directory authority system 504. For example, the client device 502 may display an interface corresponding to an authentication library, such as Microsoft

Authentication Library (MSAL) (Microsoft Corporation of Redmond Washington). For example, the client device 502 may display a webview user interface that is owned and/or otherwise associated with the authentication library. In some instances, this may be an optional step. For example, if the user has already authenticated to the cloud directory authority system 504 via the authentication library or has previously logged onto the client device 502 using their cloud directory credentials, the authentication library may remember the authentication state, and might not re-prompt for the cloud directory credentials. In some instances, the authentication library may be replaced by making application programming interface (API) calls to the cloud directory authority system 504.

At step 605, the cloud directory authority system 504 may send an access token response to the client device 502. For example, based on validating the user's cloud directory credentials, the cloud directory authority system 504 may send the access token response. In some instances, in sending the access token response, the cloud directory authority system 504 may send the access token itself (e.g., a remote session access token). In some instances, in sending the access token, the cloud directory authority system 504 may send an access token that is specific to both the user and the remote desktop server 503.

At step 606, the client device 502 may request a client cloud directory nonce from the cloud directory authority system 504. For example, the client device 502 may send, along with the client cloud directory nonce request, the correlation identifier (generated at step 602).

Referring to FIG. 6B, at step 607, the cloud directory authority system 504 may send a client cloud directory nonce response to the client device 502. For example, the cloud directory authority system 504 may send the client cloud directory nonce response to the client device 502 based on validation of the correlation identifier. In some instances, in sending the client cloud directory nonce response, the cloud directory authority system 504 may send the client cloud directory nonce itself.

At step 608, the client device 502 may send a server cloud directory nonce request to the remote desktop server 503. For example, the client device 502 may send, along with the server cloud directory nonce request, the correlation identifier (generated at step 602).

At step 609, the remote desktop server 503 may forward the server cloud directory nonce request to the cloud directory authority system 504. For example, the remote desktop server 503 may forward the server cloud directory nonce request along with the correlation identifier.

At step 610, the cloud directory authority system 504 may send a server cloud directory nonce response to the remote desktop server 503. In some instances, in sending the server cloud directory nonce response, the cloud directory authority system 504 may send the server cloud directory nonce itself.

In some instances, rather than requesting the server cloud directory nonce form the cloud directory authority system 504 (as described with regard to steps 609 and 610), the remote desktop server may directly generate the server cloud directory nonce itself.

At step 611, the remote desktop server 503 may forward the server cloud directory nonce response to the client device 502. For example, the remote desktop server 503 may forward the server cloud directory nonce itself.

At step 612, the client device 502 may generate an RDP assertion. For example, the client device 502 may concatenate the access token (received at step 605), the server cloud directory nonce (received at step 611), the client cloud directory nonce (received at step 607), and the public key of the binding key (generated at step 601).

Referring to FIG. 6C, at step 613, the client device 502 may sign the RDP assertion (generated at step 612). For example, the client device 502 may sign the RDP assertion using the private key of the binding key (generated at step 601).

At step 614, the client device 502 may send the signed RDP assertion to the remote desktop server 503. At step 615, the remote desktop server 503 may send an RDP assertion validation request to the cloud directory authority system 504. For example, the remote desktop server 503 may forward the signed RDP assertion (received at step 614), along with the correlation identifier (received at step 608), to the cloud directory authority system, and may request validation of the signed RDP assertion.

At step 616, the cloud directory authority system 504 may validate the RDP assertion, and send an RDP assertion validation response to the remote desktop server 503. In some instances, in sending the RDP assertion validation response, the cloud directory authority system 504 may send a credentials blob, which may, e.g., be configured to allow the user to login to a remote session at the remote desktop server 503.

At step 617, the remote desktop server 503 may log the user into a remote session. For example, the remote desktop server 503 may validate the credentials blob, and may log the user into the remote session based on successful validation of the credentials blob. For example, the remote desktop server 503 may submit the credentials blob to a logon user interface via an SSO credential provider (e.g., a non-interactive credential provider, such as a credential provider with no user interface, because the credentials blob may already be available) to perform a logon (or unlock) for a remote desktop session.

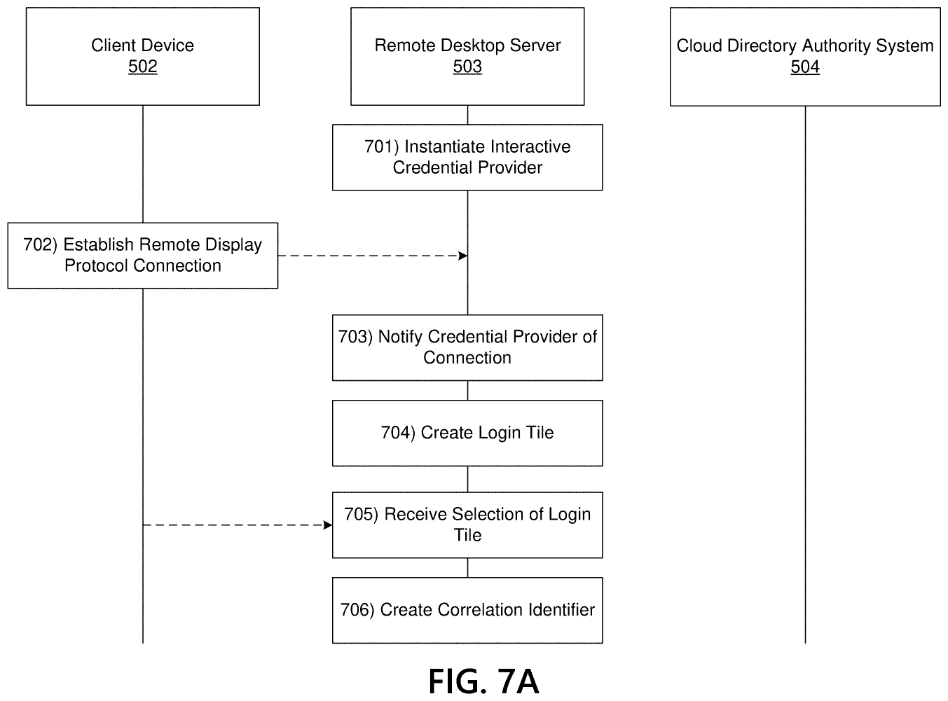

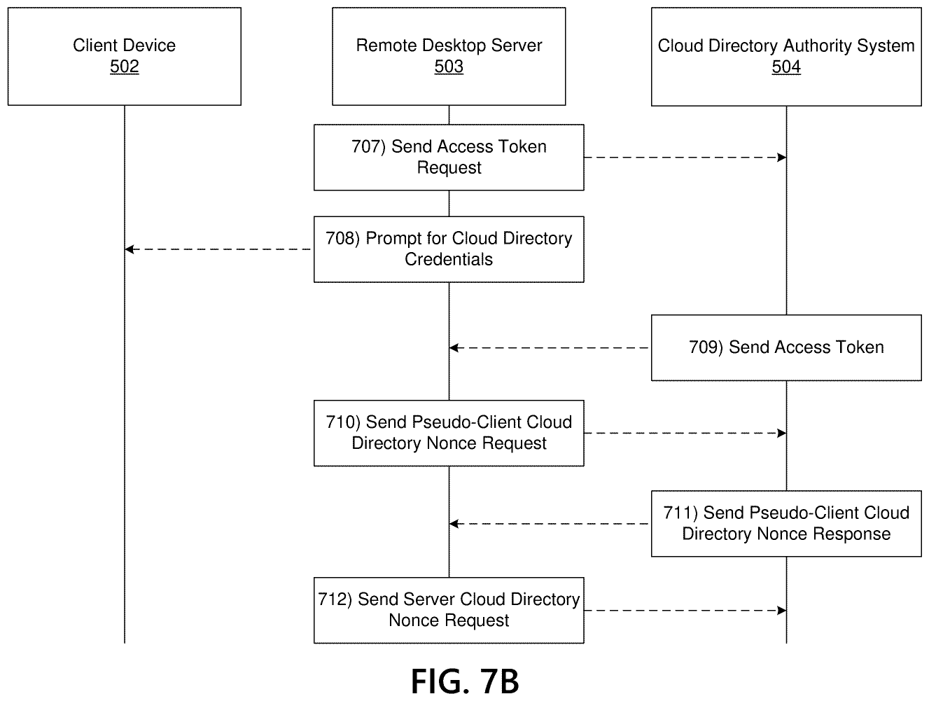

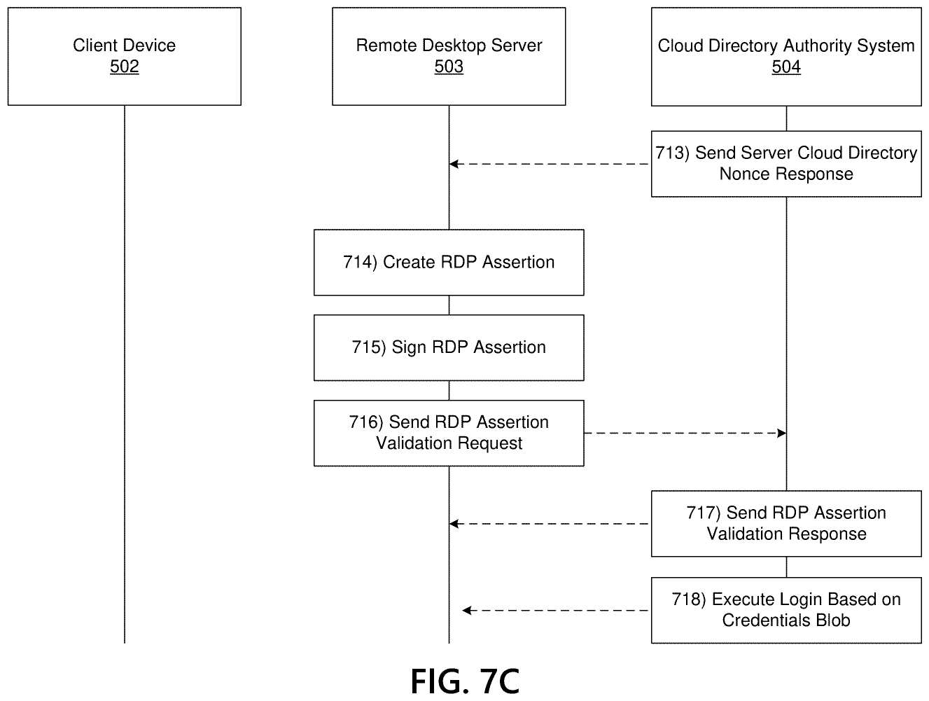

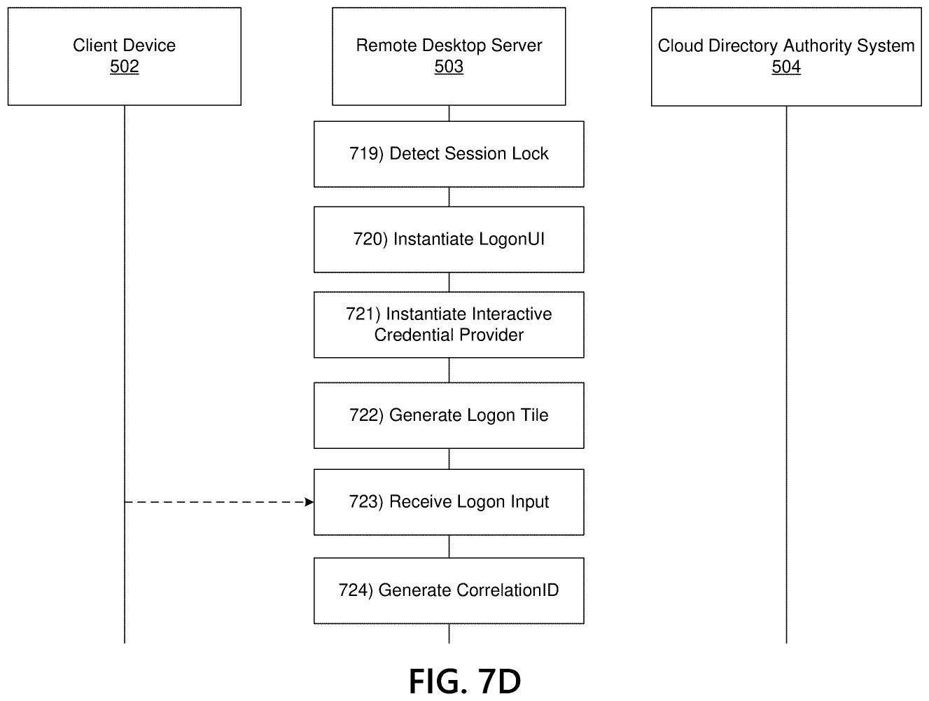

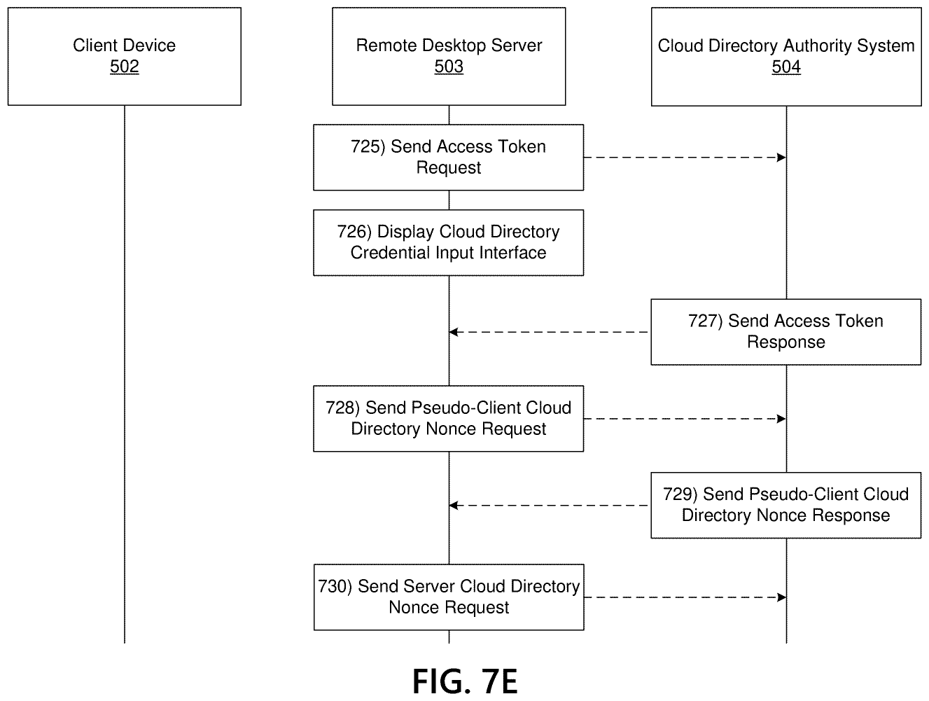

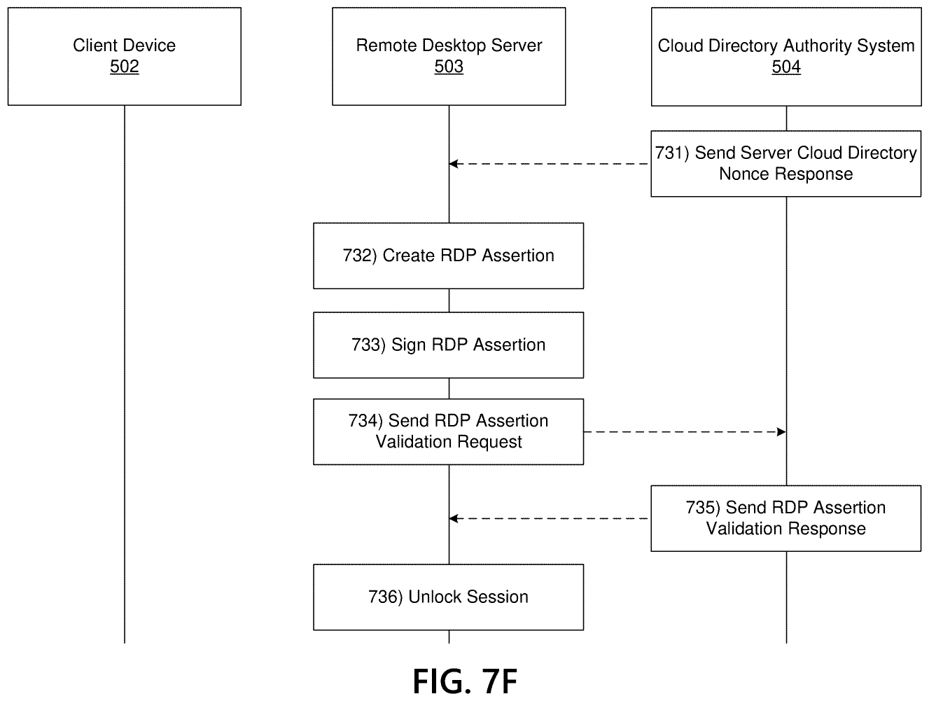

FIGS. 7A-7F depict an illustrative event sequence for remote server authentication using an SSO authentication protocol and an interactive credential provider in accordance with one or more example embodiments. It should be understood that steps 701-736 may, in some instances, occur in the order as shown with regard to FIGS. 7A-7F. For example, after completing step 706 of FIG. 7A, the event sequence may proceed to step 707 of FIG. 7B. In contrast to the method illustrated in the event sequence of FIGS. 6A-6C, which illustrate execution of an cloud directory SSO authentication protocol that includes communication from the client device 502, the event sequence of FIGS. 7A-7F illustrates logging on to and unlocking a locked remote session by executing an cloud directory SSO authentication protocol entirely on the remote desktop server 503.

Referring to FIG. 7A, at step 701, the remote desktop server 503 may instantiate an interactive credential provider (e.g., interactive credential provider 512c). For example, the remote desktop server 503 may instantiate an cloud directory credential provider, which may, for example, be a component object model (COM) component loaded into a logon user interface. In some instances, the interactive credential provider may be configured to command the logon user interface to display user interface elements (e.g., a tile, an input password field, and/or other elements), package credentials, and/or other information.

In some instances, by instantiating the interactive credential provider, the remote desktop server 503 may cause the interactive credential provider to create a binding key. In some instances, in creating the binding key, the interactive credential provider may perform actions similar to those described above with regard to step 601. For example, the client device 502 may generate a Rivest-Shamir-Adleman (RSA) public/private keypair, which may be used to request an access token (e.g., a remote session access token) from the cloud directory authority system 504, bind remote desktop protocol (RDP) assertions to a user of the client device 502, and/or to perform other actions. In some instances, in generating the binding key, the client device 502 may use biometric information such as a thumbprint corresponding to the user.

At step 702, the client device 502 may establish a remote display protocol (RDP) connection with the remote desktop server 503. For example, the client device 502 may send a username hint, associated with a user of the client device 502, to the remote desktop server 503. In these instances, the remote desktop server 503 may receive the username hint at the remote desktop service 512a (which may, e.g., include components of the remote desktop server 503 such as a protocol stack, session manager, and/or other components).

At step 703, the remote desktop server 503 may notify the interactive credential provider of the remote display protocol connection (established at step 702). For example, the remote desktop service 512a may notify the interactive credential provider.

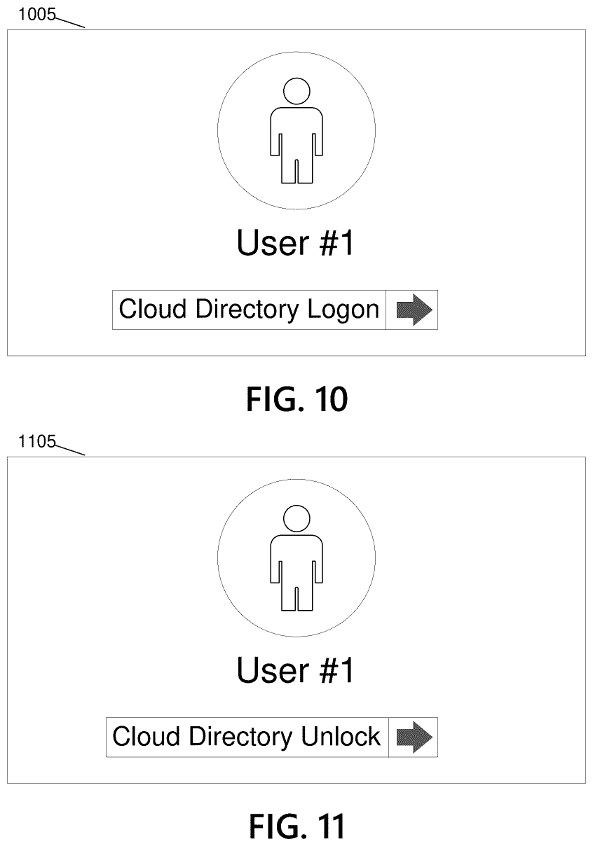

At step 704, the remote desktop server 503 may generate, using the interactive credential provider, a login interface element (e.g., a tile, button, or the like). For example, the interactive credential provider may command the logon user interface (e.g., of the session login service 512b) to display the login interface element. For example, the remote desktop server 503 may cause display (e.g., at the client device 502) of a graphical user interface similar to graphical user interface 1005, which is illustrated in FIG. 10, and which may, for example, include a selectable interface element (e.g., the session login interface element), such as the arrow depicted alongside the cloud directory logon interface element, and/or other selectable interface elements (buttons, tiles, icons, or the like).

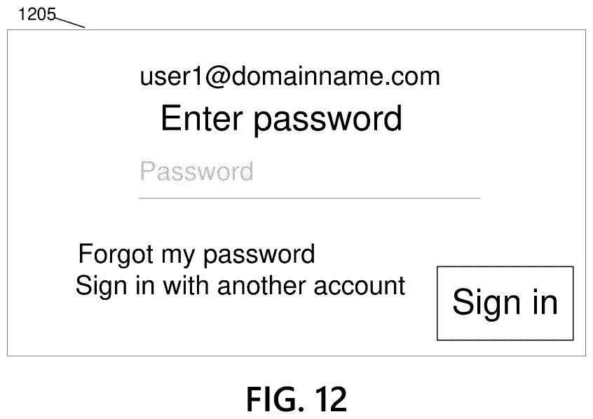

At step 705, the remote desktop server 503 may receive (e.g., at the interactive credential provider) a selection of the login interface element (e.g., via the logon user interface). In these instances, selection of this interface element may cause display of an authentication library webview user interface window (e.g., as a child window (Z-order) of the login user interface main window). For example, a graphical user interface similar to graphical user interface 1205 (which is shown in FIG. 12) may be displayed as a child window of the graphical user interface 1005.

At step 706, the remote desktop server 503 may create a correlation identifier. For example, the remote desktop server 503 may use the interactive credential provider to create the correlation identifier. In some instances, the interactive credential provider may perform similar actions to those described above with regard to the client device 502 at step 602. For example, the remote desktop server 503 may generate a unique correlation identifier that may be used for tracing and/or telemetry of communications between the client device 502 and the remote desktop server 503 and/or the cloud directory authority system 504.

Referring to FIG. 7B, at step 707, the remote desktop server 503 may send a request to the cloud directory authority system 504 for an access token (e.g., a remote session access token). For example, the remote desktop server 503 may use the interactive credential provider to request the access token. In some instances, the remote desktop server 503 may perform actions similar to those described above with regard to the client device 502 at step 603. For example, remote desktop server 503 may send a request to the cloud directory authority system 504 for an access token for a target machine (e.g., the remote desktop server 503) on behalf of the user of the client device 502. In some instances, in sending the access token request, the remote desktop server 503 may send a device identifier of the cloud directory authority system 504, a username hint for the user (e.g., received at step 702), a thumbprint corresponding to the public key of the binding key (e.g., generated at step 701), an identifier of the client device 502, and the correlation identifier (generated at step 706).

At step 708, the remote desktop server 503 may prompt for the user's cloud directory credentials. For example, the remote desktop server 503 may use the interactive credential provider to perform actions similar to those described above with regard to the client device 502 at step 604. For example, the interactive credential provider may cause display of an interface requesting the user's credentials to access the cloud directory authority system 504. For example, interactive credential provider may cause display of an interface corresponding to an authentication library, such as Microsoft Authentication Library (MSAL) (Microsoft Corporation of Redmond Washington). For example, the interactive credential provider may display a webview user interface that is owned and/or otherwise associated with the authentication library. In some instances, this may be an optional step. For example, if the user has already authenticated to the cloud directory authority system 504 via the authentication library or has previously logged onto the client device 502 using their cloud directory credentials, the authentication library may remember the authentication state, and might not re-prompt for the cloud directory credentials. In some instances, the authentication library may be replaced by making application programming interface (API) calls to the cloud directory authority system 504.

At step 709, the cloud directory authority system 504 may send an access token response to the remote desktop server 503. For example, the cloud directory authority system 504 may perform actions similar to those described above with regard to step 605. For example, based on validating the user's cloud directory credentials, the cloud directory authority system 504 may send the access token response to the interactive credential provider. In some instances, in sending the access token response, the cloud directory authority system 504 may send the access token itself (e.g., a remote session access token). In some instances, in sending the access token, the cloud directory authority system 504 may send an access token that is specific to both the user and the remote desktop server 503.

At step 710, the remote desktop server 503 may request a client cloud directory nonce from the cloud directory authority system 504. For example, the remote desktop server 503 may use the interactive credential provider to request the client cloud directory nonce. In some instances, actions performed at step 710 may be similar to those described above with regard to the client device 502 at step 606. For example, the interactive credential provider may send, along with the client cloud directory nonce request, the correlation identifier (generated at step 706).

At step 711, the cloud directory authority system 504 may send a client cloud directory nonce response to the remote desktop server 503. For example, the cloud directory authority system 504 may send the client cloud directory nonce response to the interactive credential provider. In some instances, the actions performed at step 711 may be similar to those described above with regard to step 607. For example, the cloud directory authority system 504 may send the client cloud directory nonce response to the interactive credential provider based on validation of the correlation identifier. In some instances, in sending the client cloud directory nonce response, the cloud directory authority system 504 may send the client cloud directory nonce itself.

In some instances, this authentication to the cloud directory authority may include prompting for an input at an MFA physical device, biometric sensor, or the like that may be connected to the client device 502. In these instances, the authentication may still be achieved as long as the remote display protocol remotes the MFA device between the client device 502 and the remote desktop server 503. For example, if the cloud directory authentication requires a smart card that is inserted in a reader connected to the client device 502, the authentication may still happen if the remote display protocol remotes the smart card to the remote desktop server 503 (e.g., via smart card redirection over a dedicated virtual channel protocol).

In some instances, the cloud directory authentication might not always be doable entirely from the server side. For example, the authentication may require an MFA physical device that is connected to the client device 502, where the remote display protocol might not remote the MFA device between the client device 502 and the remote desktop server 503. As another example, the cloud directory authentication may rely on a third party identity provider (IDP) that might not be available (or reachable) from the remote desktop server. As yet another example, such cloud directory authentication might not be doable entirely from the server side if additional constraints are added to the cloud directory SSO authentication protocol. For example, it may be possible for the cloud directory to detect that the client device 502 is different from the remote desktop server 503. Subsequently, the cloud directory may enforce the constraint that they must be different before allowing authentication to proceed.

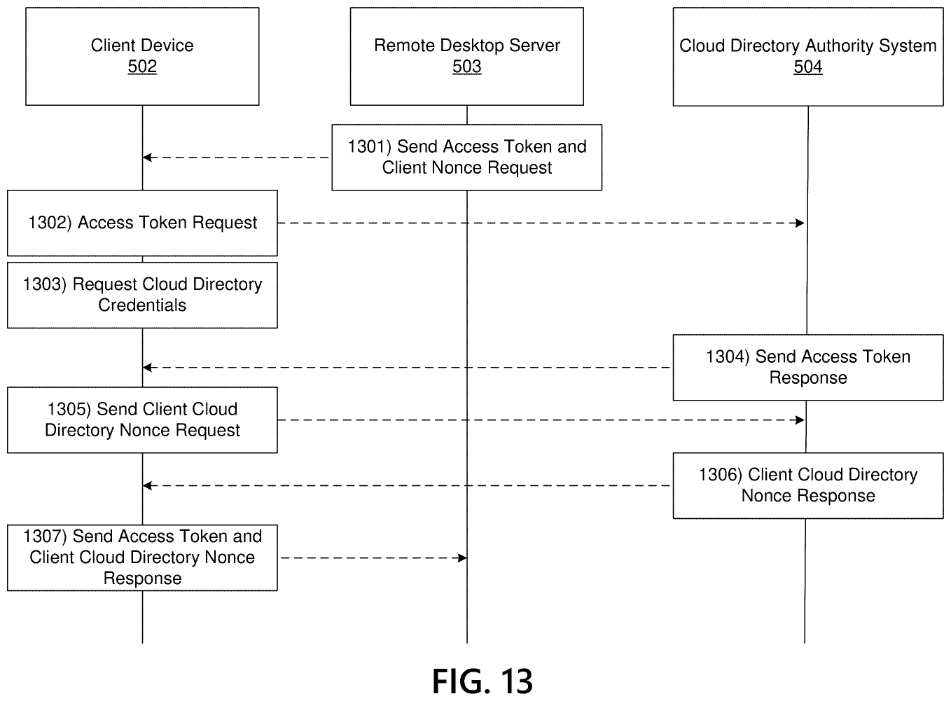

In these instances, the interactive credential provider may work in combination with a reverse authentication client-side component to perform some of the cloud directory requests (e.g., obtain an access token and a client cloud directory nonce). For example, steps 707-711 (as described above with regard to FIG. 7B), may be replaced with reverse seamless authentication process as is illustrated in FIG. 13. For example, the cloud directory requests may be remoted from the remote desktop server 503 to the client device 502 over the remote display protocol. For example, the requests may be remoted over a virtual channel protocol of the remote display protocol, and received via a reverse authentication client-side component.

More specifically, as illustrated in FIG. 13, at step 1301, the remote desktop server 503 may send the access token (e.g., a remote session access token) and client nonce request to the client device 502. For example, the interactive credential provider may send the access token and client cloud directory nonce request to general server components of the remote desktop server 503 (e.g., remote desktop service 512a). These general server components may then route the access token and client cloud directory nonce request to the client device 502. In some instances, in sending the access token and client cloud directory nonce request, the interactive credential provider and/or general server components may send a server identifier, binding public key, correlation identifier, and/or other information. In some instances, the access token and client nonce request may be sent to the client device 502 via the remote display protocol.

At step 1302, the client device 502 may send the access token request to the cloud directory authority system 504. For example, the client device 502 may send the server identifier, binding public key, and correlation identifier received at step 1301, along with a client identifier.

At step 1303, the client device 502 may request cloud directory credentials. For example, the client device 502 may cause display of an interface requesting the user's credentials to access the cloud directory authority system 504. For example, interactive credential provider may cause display of an interface corresponding to an authentication library, such as Microsoft Authentication Library (MSAL) (Microsoft Corporation of Redmond Washington). For example, the interactive credential provider may display a webview user interface that is owned and/or otherwise associated with the authentication library.

In some instances, the interface may be displayed on top of a client-side window (possibly full screen) that shows the entire server-side display (via the remote display protocol). In some instances, the client-side window may be a child window of the server-side display. Alternatively, the client side window may be directly integrated within the server-side display using the reverse seamless process.

At step 1304, the cloud directory authority system 504 may send the access token response to the client device 502. For example, the cloud directory authority system 504 may send the access token for the cloud directory authority (e.g., a remote session access token).

At step 1305, the client device 502 may send the client cloud directory nonce request to the cloud directory authority system 504. For example, the client device 502 may send the correlation identifier received at step 1301.

At step 1306, the cloud directory authority system 504 may send the client cloud directory nonce response. For example, the cloud directory authority system 504 may send the client cloud directory none to the client device 502.

At step 1307, the client device 502 may send the access token and the client cloud directory nonce response to the remote desktop server 503. For example, the client device 502 may send the access token and the client cloud directory nonce to the general server components of the remote desktop server 503, which may forward the access token and the client cloud directory nonce to the interactive credential provider. In some instances, the client device 502 may send the access token and the client cloud directory nonce response via the remote display protocol.

By performing such reverse authentication with a client side component (as described with regard to steps 1301-1307, the cloud directory authentication may still be completed despite authentication requirements that may prevent the cloud directory authentication from being performed solely from the server side. For example, the end user experience may be the same in these instances as when the interactive credential provider is used to perform the cloud directory authentication entirely from the server side (as is described with regard to FIGS. 7A-7F).

Returning to FIG. 7B, at step 712, the remote desktop server 503 may send a server cloud directory nonce request to the cloud directory authority system 504. For example, the interactive credential provider may send the server cloud directory nonce request. In some instances, actions performed at step 712 may be similar to those described above with regard to steps 608 and 609. For example, the client device 502 may send, along with the server cloud directory nonce request, the correlation identifier (generated at step 706).

Referring to FIG. 7C, at step 713, the cloud directory authority system 504 may send a server cloud directory nonce response to the remote desktop server 503. For example, the cloud directory authority system 504 may send the server cloud directory nonce response to the interactive credential provider. In some instances, actions performed at step 713 may be similar to those described above with regard to steps 610 and 611. For example, the cloud directory authority system 504 may send the server cloud directory nonce response to the remote desktop server 503 based on validation of the correlation identifier. In some instances, in sending the server cloud directory nonce response, the cloud directory authority system 504 may send the server cloud directory nonce itself.

At step 714, the remote desktop server 503 may generate an RDP assertion. For example, the remote desktop server 503 may use the interactive credential provider to generate the RDP assertion. In some instances, actions performed at step 714 may be similar to those described above with regard to the client device 502 at step 612. For example, the interactive credential provider may concatenate the access token (received at step 709), the server cloud directory nonce (received at step 713), the client cloud directory nonce (received at step 711), and the public key of the binding key (generated at step 701).

At step 715, the remote desktop server 503 may sign the RDP assertion (generated at step 714). For example, the remote desktop server 503 may sign the RDP assertion using the interactive credential provider. In some instances, actions performed at step 715 may be similar to those described above with regard to the client device 502 at step 613. For example, the interactive credential provider may sign the RDP assertion using the private key of the binding key (generated at step 701).

At step 716, the remote desktop server 503 may send the signed RDP assertion to the cloud directory authority system 504. For example, the remote desktop server 503 may send the signed RDP assertion using the interactive credential provider. In these instances, the interactive credential provider may send the signed RDP assertion (generated at 715) along with the correlation identifier (generated at step 706) to the cloud directory authority system 504, and may request validation of the RDP assertion. In some instances, actions performed at step 716 may be similar to those described above with regard to steps 615 and 616 as described above.

At step 717, the cloud directory authority system 504 may validate the RDP assertion, and send an RDP assertion validation response to the remote desktop server 503 (e.g., to the interactive credential provider). In some instances, in sending the RDP assertion validation response, the cloud directory authority system 504 may send a packaged credentials blob, which may, e.g., be configured to allow the user to login to a remote session at the remote desktop server 503.

At step 718, the remote desktop server 503 may use the interactive credential provider to submit the packaged credentials blob to the logon user interface to log the user into a remote session. For example, the remote desktop server 503 may send, via the logon user interface, the packaged credentials blob to a logon processes, and ultimately to a remote desktop server local security authority. In some instances, this remote desktop server local security authority may act as a session login service, and may interact with the cloud directory authority system 504 to allow the logon or unlock of the remote session.

While steps 701-718 refer to an initial login to a remote desktop session using an SSO authentication protocol and an interactive credential provider, steps 719-736 (as described below) refer to a session unlock process, in which a user was logged into the remote desktop session but the session has become locked due to the user directly locking the session, a timeout, inactivity, and/or otherwise.

Referring to FIG. 7D, at step 719, the remote desktop server 503 may detect a session lock. For example, the remote desktop server 503 may detect that the user has been logged off or otherwise locked out of the remote desktop session established at step 718.

At step 720, the remote desktop server 503 may instantiate a logon user interface. At step 721, the remote desktop server 503 may use the logon user interface to instantiate the interactive credential provider. For example, the remote desktop server 503 may perform similar actions to those described above with regard to step 701. For example, the remote desktop server 503 may instantiate an cloud directory credential provider, which may, for example, be a component object model (COM) component loaded into a logon user interface. In some instances, the interactive credential provider may be configured to command the logon user interface to display user interface elements (e.g., a tile, an input password field, and/or other elements), package credentials, and/or other information.

At step 722, the remote desktop server 503 may generate, using the interactive credential provider, a login interface element (e.g., a tile, button, or the like). In some instances, actions performed at step 722 may be similar to those described above with regard to step 704. For example, the interactive credential provider may command the logon user interface (e.g., of the session login service 512b) to display the login interface element. For example, the remote desktop server 503 may cause display (e.g., at the client device 502) of a graphical user interface similar to graphical user interface 1005, which is illustrated in FIG. 11, and which may, for example, include a selectable interface element (e.g., the session login interface element), such as the arrow depicted alongside the cloud directory unlock interface element, and/or other selectable interface elements (buttons, tiles, icons, or the like).

At step 723, the remote desktop server 503 may receive (e.g., at the interactive credential provider) a selection of the login interface element (e.g., via the logon user interface). In these instances, selection of this interface element may cause display of an authentication library webview user interface window (e.g., as a child window (Z-order) of the login user interface main window). For example, a graphical user interface similar to graphical user interface 1205 (which is shown in FIG. 12) may be displayed as a child window of the graphical user interface 1105. In some instances, actions performed at step 723 may be similar to those described above with regard to step 705.

At step 724, the remote desktop server 503 may create a correlation identifier. For example, the remote desktop server 503 may use the interactive credential provider to create the correlation identifier. In some instances, the interactive credential provider may perform similar actions to those described above with regard to step 706. For example, the remote desktop server 503 may generate a unique correlation identifier that may be used for tracing and/or telemetry of communications between the client device 502 and the remote desktop server 503 and/or the cloud directory authority system 504.

Referring to FIG. 7E, at step 725, the remote desktop server 503 may send a request to the cloud directory authority system 504 for an access token (e.g., a remote session access token). For example, the remote desktop server 503 may use the interactive credential provider to request the access token. In some instances, the remote desktop server 503 may perform actions similar to those described above with regard to step 707. For example, remote desktop server 503 may send a request to the cloud directory authority system 504 for an access token for a target machine (e.g., the remote desktop server 503) on behalf of the user of the client device 502. In some instances, in sending the access token request, the remote desktop server 503 may send a device identifier of the cloud directory authority system 504, a username hint for the user (e.g., received at step 702), a thumbprint corresponding to the public key of the binding key (e.g., generated at step 701), an identifier of the client device 502, and the correlation identifier (generated at step 724).

At step 726, the remote desktop server 503 may prompt for the user's cloud directory credentials. For example, the remote desktop server 503 may use the interactive credential provider to perform actions similar to those described above with regard to step 708. For example, the interactive credential provider may cause display of an interface requesting the user's credentials to access the cloud directory authority system 504. For example, interactive credential provider may cause display of an interface corresponding to an authentication library, such as Microsoft Authentication Library (MSAL) (Microsoft Corporation of Redmond Washington). For example, the interactive credential provider may display a webview user interface that is owned and/or otherwise associated with the authentication library. In some instances, this may be an optional step. For example, if the user has already authenticated to the cloud directory authority system 504 via the authentication library or has previously logged onto the client device 502 using their cloud directory credentials, the authentication library may remember the authentication state, and might not re-prompt for the cloud directory credentials. In some instances, the authentication library may be replaced by making application programming interface (API) calls to the cloud directory authority system 504.

At step 727, the cloud directory authority system 504 may send an access token response to the remote desktop server 503. For example, the cloud directory authority system 504 may perform actions similar to those described above with regard to step 709. For example, based on validating the user's cloud directory credentials, the cloud directory authority system 504 may send the access token response to the interactive credential provider. In some instances, in sending the access token response, the cloud directory authority system 504 may send the access token itself (e.g., a remote session access token). In some instances, in sending the access token, the cloud directory authority system 504 may send an access token that is specific to both the user and the remote desktop server 503.

At step 728, the remote desktop server 503 may request a client cloud directory nonce from the cloud directory authority system 504. For example, the remote desktop server 503 may use the interactive credential provider to request the client cloud directory nonce. In some instances, actions performed at step 728 may be similar to those described above with regard to step 710. For example, the interactive credential provider may send, along with the client cloud directory nonce request, the correlation identifier (generated at step 724).

At step 729, the cloud directory authority system 504 may send a client cloud directory nonce response to the remote desktop server 503. For example, the cloud directory authority system 504 may send the client cloud directory nonce response to the interactive credential provider. In some instances, the actions performed at step 729 may be similar to those described above with regard to step 711. For example, the cloud directory authority system 504 may send the client cloud directory nonce response to the interactive credential provider based on validation of the correlation identifier. In some instances, in sending the client cloud directory nonce response, the cloud directory authority system 504 may send the client cloud directory nonce itself.

As is described above with regard to an initial login process, the cloud directory authentication may, in some instances, be performed using a reverse seamless client side method (e.g., as is described above with regard to FIG. 13). In some instances, this reverse seamless method depicted in FIG. 13 may similarly be used to unlock a locked session. For example, steps 725-729 may be replaced by steps 1301-1307, which are described above with regard to FIG. 13.

At step 730, the remote desktop server 503 may send a server cloud directory nonce request to the cloud directory authority system 504. For example, the interactive credential provider may send the server cloud directory nonce request. In some instances, actions performed at step 730 may be similar to those described above with regard to step 712. For example, the client device 502 may send, along with the server cloud directory nonce request, the correlation identifier (generated at step 724).

Referring to FIG. 7F, at step 731, the cloud directory authority system 504 may send a server cloud directory nonce response to the remote desktop server 503. For example, the cloud directory authority system 504 may send the server cloud directory nonce response to the interactive credential provider. In some instances, actions performed at step 731 may be similar to those described above with regard to step 713. For example, the cloud directory authority system 504 may send the server cloud directory nonce response to the remote desktop server 503 based on validation of the correlation identifier. In some instances, in sending the server cloud directory nonce response, the cloud directory authority system 504 may send the server cloud directory nonce itself.

At step 732, the remote desktop server 503 may generate an RDP assertion. For example, the remote desktop server 503 may use the interactive credential provider to generate the RDP assertion. In some instances, actions performed at step 732 may be similar to those described above with regard to the client device 502 at step 714. For example, the interactive credential provider may concatenate the access token (received at step 727), the server cloud directory nonce (received at step 729), the client cloud directory nonce (received at step 731), and the public key of the binding key (generated at step 721).

At step 733, the remote desktop server 503 may sign the RDP assertion (generated at step 731). For example, the remote desktop server 503 may sign the RDP assertion using the interactive credential provider. In some instances, actions performed at step 733 may be similar to those described above with regard to step 715. For example, the interactive credential provider may sign the RDP assertion using the private key of the binding key (generated at step 721).

At step 734, the remote desktop server 503 may send the signed RDP assertion to the cloud directory authority system 504. For example, the remote desktop server 503 may send the signed RDP assertion using the interactive credential provider. In these instances, the interactive credential provider may send the signed RDP assertion (generated at 733) along with the correlation identifier (generated at step 724) to the cloud directory authority system 504, and may request validation of the RDP assertion. In some instances, actions performed at step 734 may be similar to those described above with regard to steps 716.

At step 735, the cloud directory authority system 504 may validate the RDP assertion, and send an RDP assertion validation response to the remote desktop server 503 (e.g., to the interactive credential provider). In some instances, in sending the RDP assertion validation response, the cloud directory authority system 504 may send a packaged credentials blob, which may, e.g., be configured to allow the user to unlock the remote session at the remote desktop server 503. In some instances, actions performed at step 735 may be similar to those described above with regard to step 717.

At step 736, the remote desktop server 503 may use the interactive credential provider to submit the packaged credentials blob to the logon user interface to log the user into a remote session. For example, the remote desktop server 503 may send, via the logon user interface, the packaged credentials blob to a logon processes, and ultimately to a remote desktop server local security authority. In some instances, this remote desktop server local security authority may act as a session login service, and may interact with the cloud directory authority system 504 to allow the logon or unlock of the remote session. In some instances, actions performed at step 736 may be similar to those described above with regard to step 718.

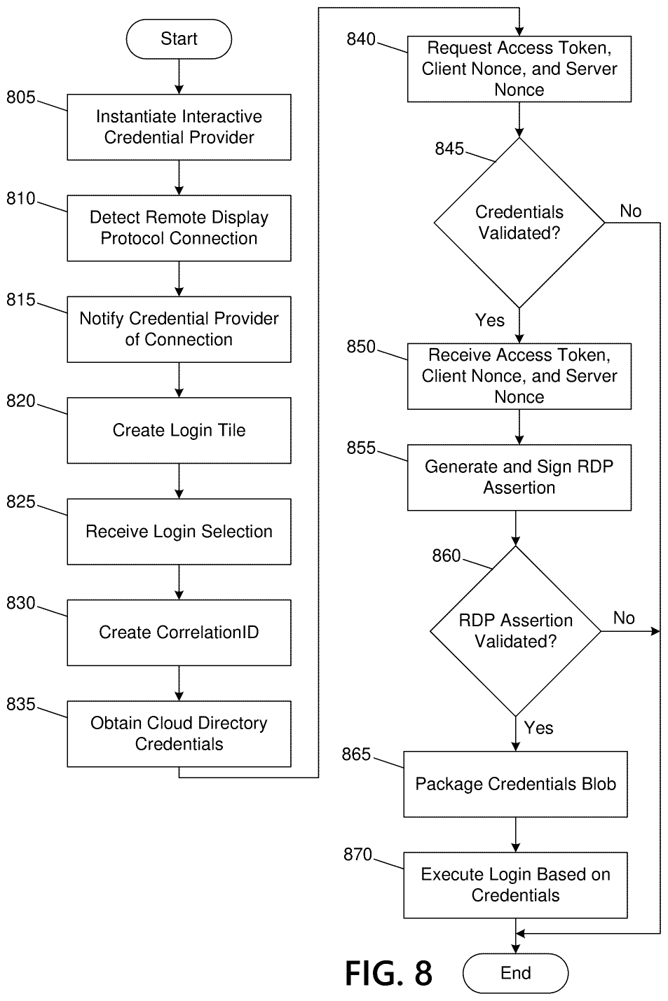

FIG. 8 depicts an illustrative method for remote server authentication using an SSO authentication protocol and an interactive credential provider for a remote desktop session login in accordance with one or more example embodiments. Referring to FIG. 8, at step 805, a computing system comprising a memory and one or more processors may instantiate an interactive credential provider. At step 810, the computing system may detect an RDP connection with a client device. At step 815, the computing system may notify the interactive credential provider of the RDP connection. At step 820, the computing system may create a login tile for a login user interface. At step 825, the computing system may receive user input corresponding to the login tile. At step 830, the computing system may generate a correlation identifier for the client device. At step 835, the computing system may obtain cloud directory credentials for an cloud directory authority system. At step 840, the computing system may request an access token, client nonce, and server nonce from the cloud directory authority system. At step 845, the computing system may identify whether or not the cloud directory credentials are validated. If the cloud directory credentials are validated, the computing system may proceed to step 850. If the cloud directory credentials are not validated, the method may end.

At step 850, the computing system may receive the access token, client nonce, and server nonce. At step 855, the computing system may generate and sign an RDP assertion based on the access token, client nonce, and server nonce. At step 860, the computing system may communicate with the cloud directory authority system to validate the RDP assertion. If the RDP assertion is not validated, the method may end. If the RDP assertion is validated, the computing system may receive a credentials blob and proceed to step 865. At step 865, the computing system may package the credentials blob for executing a login process. At step 870, the computing system may execute a remote desktop session login based on the credentials blob.

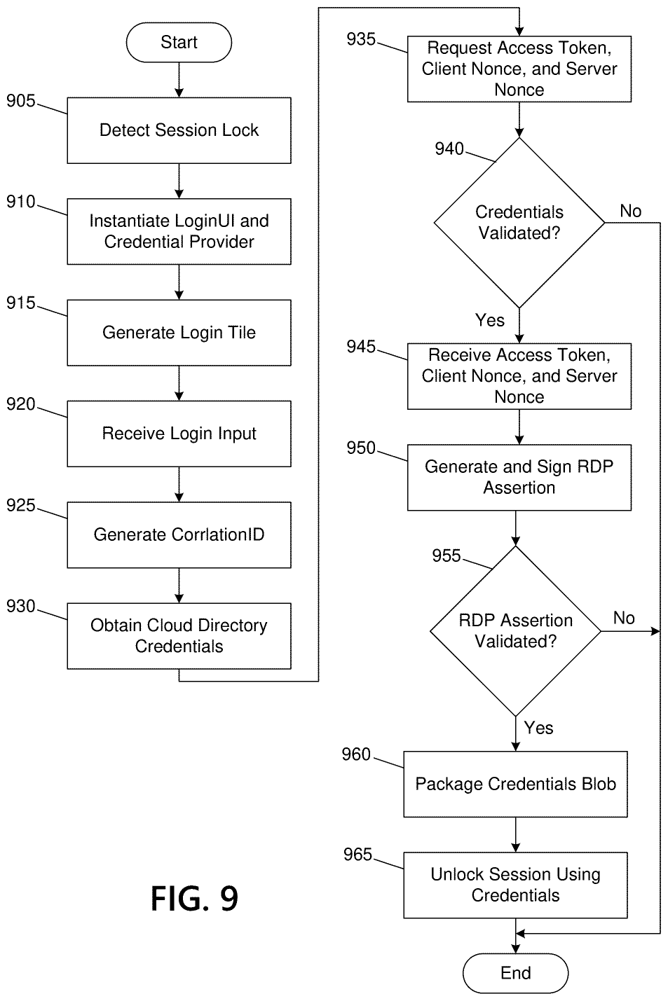

FIG. 9 depicts an illustrative method for remote server authentication using an SSO authentication protocol and an interactive credential provider for a remote desktop session unlock in accordance with one or more example embodiments. Referring to FIG. 9, at step 905, a computing system comprising a memory and one or more processors may detect a session lock for a remote desktop session. At step 910, the computing system may instantiate a login user interface and a credential provider. At step 915, the computing system may generate a login tile. At step 920, the computing system may receive a login input via the tile. At step 925, the computing system may generate a correlation identifier. At step 930, the computing system may obtain cloud directory credentials. At step 935, the computing system may request an access token, client nonce, and server nonce from an cloud directory authority system. At step 940, the computing system may identify whether or not the cloud directory credentials are validated. If the cloud directory credentials are not validated, the method may end. If the cloud directory credentials are validated, the computing system may proceed to step 945. At step 945, the computing system may receive the access token, the client nonce, and the server nonce. At step 950, the computing system may use the access token, client nonce, and server nonce to generate and sign an RDP assertion. At step 955, the computing system may communicate with the cloud directory authority system to validate the RDP assertion. If the cloud directory assertion is not validated, the method may end. If the cloud directory assertion is validated, the computing system may receive a credentials blob from the cloud directory authority system. At step 960, the computing system may package the credentials blob for executing a session unlock process. At step 965, the computing system may unlock the remote desktop session using the credentials blob.

The following paragraphs (M1) through (M12) describe examples of methods that may be implemented in accordance with the present disclosure.
(M1) A method comprising: instantiating, at a remote desktop server, an interactive credential provider; receiving, from a client device, a notification of a remote display protocol connection; executing, based on the notification of the remote display protocol connection, by the interactive credential provider, and with a cloud directory authority, a single sign on (SSO) protocol, wherein the SSO protocol is configured for use between the client device and the remote desktop server; and performing, based on successful execution of the SSO protocol and for the client device, a login to a remote session between the client device and the remote desktop server.
(M2) A method may be performed as described in paragraph (M1), further comprising: detecting session lock for the remote session; instantiating the interactive credential provider; receiving, by the interactive credential provider, selection of a session unlock interface element; executing, based on the selection of the session unlock interface element, by the interactive credential provider, and with the cloud directory authority, the SSO protocol; and unlocking, based on successful execution of the SSO protocol and for the client device, the remote session.
(M3) A method may be performed as described in any one of paragraphs (M1) through (M2), further comprising generating, by the interactive credential provider, a public-private keypair, wherein executing, the SSO protocol comprises executing, using the public-private keypair, the SSO protocol.
(M4) A method may be performed as described in paragraph (M3), wherein instantiating the interactive credential provider generates the public-private keypair, and wherein the public-private keypair comprises a Rivest-Shamir-Adleman public-private keypair.
(M5) A method may be performed as described in any one of paragraphs (M1) through (M4), wherein the notification of the remote display protocol connection includes a username hint for a user of the client device.
(M6) A method may be performed as described in any one of paragraphs (M1) through (M5), wherein the interactive credential provider generates a session login interface element, and wherein executing the SSO protocol is in response to receiving selection of the session login interface element.
(M7) A method may be performed as described in any one of paragraphs (M1) through (M6), wherein executing the SSO protocol comprises: creating, by the interactive credential provider, a correlation identifier; requesting, using the correlation identifier, by the interactive credential provider, and from the cloud directory authority, a remote session access token, a pseudo-client cloud directory nonce, and a server cloud directory nonce; receiving, from the cloud directory authority, the remote session access token, the pseudo-client cloud directory nonce, and the server cloud directory nonce; creating, by the interactive credential provider, a remote desktop protocol (RDP) assertion, wherein the RDP assertion is created based on: a public key of the public-private keypair, a device identifier of the cloud directory authority, the remote session access token, the pseudo-client cloud directory nonce, and the server cloud directory nonce; signing, by the interactive credential provider, the RDP assertion; generating a request, by the interactive credential provider, for a credentials blob from the cloud directory authority, wherein the request includes the RDP assertion and the correlation identifier; and receiving, from the cloud directory authority, the credentials blob in response to the request.
(M8) A method may be performed as described in paragraph (M7), further comprising obtaining, by the interactive credential provider, cloud directory credentials for the cloud directory authority, wherein the cloud directory authority provides the remote session access token, the pseudo-client cloud directory nonce, and the server cloud directory nonce in response to validating the cloud directory credentials.
(M9) A method may be performed as described in paragraph (M8), wherein obtaining the cloud directory credentials includes obtaining user credentials from a multi-factor authentication (MFA) device connected to the client device.
(M10) A method may be performed as described in paragraph (M9), wherein obtaining the cloud directory credentials comprises, obtaining, via the remote display protocol connection and using a virtual channel protocol, the cloud directory credentials.
(M11) A method may be performed as described in paragraph (M9), wherein obtaining the cloud directory credentials comprises performing a reverse seamless authentication process with the client device, wherein the reverse authentication process comprises: routing, via the remote display protocol connection and to the client device, a request for the cloud directory credentials.
(M12) A method may be performed as described in any one of paragraphs (M7) through (M11), wherein performing the login to the remote session is based on validation of the credentials blob.

The following paragraphs (A1) through (A7) describe examples of apparatuses that may be implemented in accordance with the present disclosure.
(A1) A computing system comprising: one or more processors; memory storing computer executable instructions that, when executed by the processor, cause the computing system to: instantiate, at the computing system, an interactive credential provider; receive, from a client device, a notification of a remote display protocol connection; execute, based on the notification of the remote display protocol connection, by the interactive credential provider, and with a cloud directory authority, a single sign on (SSO) protocol, wherein the SSO protocol is configured for use between the client device and the remote desktop server; and perform, based on successful execution of the SSO protocol and for the client device, a login to a remote session between the client device and the computing system.
(A2) A computing system as described in paragraph (A1) may detect session lock for the remote session; instantiate the interactive credential provider; receive, by the interactive credential provider, selection of a session unlock interface element; execute, based on the selection of the session unlock interface element, by the interactive credential provider, and with the cloud directory authority, the SSO protocol; and unlock, based on successful execution of the SSO protocol and for the client device, the remote session.
(A3) A computing system as described in any one of paragraphs (A1) through (A2) may generate, by the interactive credential provider, a public-private keypair, wherein executing, the SSO protocol comprises executing, using the public-private keypair, the SSO protocol.
(A4) A computing system as described in paragraph (A3), wherein instantiating the interactive credential provider generates the public-private keypair, and wherein the public-private keypair comprises a Rivest-Shamir-Adleman public-private keypair.
(A5) A computing system as described in any one of paragraphs (A1) through (A4), wherein the notification of the remote display protocol connection includes a username hint for a user of the client device.
(A6) A computing system as described in any one of paragraphs (A1) through (A5), wherein the interactive credential provider generates a session login interface element, and wherein executing the SSO protocol is in response to receiving selection of the session login interface element.
(A7) A computing system as described in any one of paragraphs (A1) through (A6), wherein executing the SSO protocol comprises: creating, by the interactive credential provider, a correlation identifier; requesting, using the correlation identifier, by the interactive credential provider, and from the cloud directory authority, a remote session access token, a pseudo-client cloud directory nonce, and a server cloud directory nonce; receiving, from the cloud directory authority, the remote session access token, the pseudo-client cloud directory nonce, and the server cloud directory nonce; creating, by the interactive credential provider, a remote desktop protocol (RDP) assertion, wherein the RDP assertion is created based on a public key of the public-private keypair, a device identifier of the cloud directory authority, the remote session access token, the pseudo-client cloud directory nonce, and the server cloud directory nonce; signing, by the interactive credential provider, the RDP assertion; generating a request, by the interactive credential provider, for a credentials blob from the cloud directory authority, wherein the request includes the RDP assertion and the correlation identifier; and receiving, from the cloud directory authority, the credentials blob in response to the request.

The following paragraph (CRM1) describes examples of computer-readable media that may be implemented in accordance with the present disclosure.
(CRM1) One or more non-transitory computer-readable media storing instructions that, when executed by a computing system comprising at least one processor, a communication interface, and memory, cause the computing system to: instantiate, at the computing system, an interactive credential provider; receive, from a client device, a notification of a remote display protocol connection; execute, based on the notification of the remote display protocol connection, by the interactive credential provider, and with a cloud directory authority, a single sign on (SSO) protocol, wherein the SSO protocol is configured for use between the client device and the remote desktop server; and perform, based on successful execution of the SSO protocol and for the client device, a login to a remote session between the client device and the computing system.

Although the subject matter has been described in language specific to structural features and/or methodological acts, it is to be understood that the subject matter defined in the appended claims is not necessarily limited to the specific features or acts described above. Rather, the specific features and acts described above are described as example implementations of the following claims.

What is claimed is:

1. A method comprising:
instantiating, at a remote desktop server, an interactive credential provider;
receiving, from a client device, a notification of a remote display protocol connection;
executing, based on the notification of the remote display protocol connection, by the interactive credential provider, and with a cloud directory authority, a single sign on (SSO) protocol, wherein the SSO protocol is configured for use between the client device and the remote desktop server; and
performing, based on successful execution of the SSO protocol and for the client device, a login to a remote session between the client device and the remote desktop server.

2. The method of claim 1, further comprising:
detecting session lock for the remote session;
instantiating the interactive credential provider;
receiving, by the interactive credential provider, selection of a session unlock interface element;
executing, based on the selection of the session unlock interface element, by the interactive credential provider, and with the cloud directory authority, the SSO protocol; and
unlocking, based on successful execution of the SSO protocol and for the client device, the remote session.

3. The method of claim 1, further comprising:
generating, by the interactive credential provider, a public-private keypair, wherein executing, the SSO protocol comprises executing, using the public-private keypair, the SSO protocol.

4. The method of claim 3, wherein instantiating the interactive credential provider generates the public-private keypair, and wherein the public-private keypair comprises a Rivest-Shamir-Adleman public-private keypair.

5. The method of claim 1, wherein the notification of the remote display protocol connection includes a username hint for a user of the client device.

6. The method of claim 1, wherein the interactive credential provider generates a session login interface element, and wherein executing the SSO protocol is in response to receiving selection of the session login interface element.

7. The method of claim 1, wherein executing the SSO protocol comprises:
creating, by the interactive credential provider, a correlation identifier;
requesting, using the correlation identifier, by the interactive credential provider, and from the cloud directory authority, a remote session access token, a pseudo-client cloud directory nonce, and a server cloud directory nonce;
receiving, from the cloud directory authority, the remote session access token, the pseudo-client cloud directory nonce, and the server cloud directory nonce;
creating, by the interactive credential provider, a remote desktop protocol (RDP) assertion, wherein the RDP assertion is created based on: a public key of the public-private keypair, a device identifier of the cloud directory authority, the remote session access token, the pseudo-client cloud directory nonce, and the server cloud directory nonce;
signing, by the interactive credential provider, the RDP assertion;
generating a request, by the interactive credential provider, for a credentials blob from the cloud directory authority, wherein the request includes the RDP assertion and the correlation identifier; and
receiving, from the cloud directory authority, the credentials blob in response to the request.

8. The method of claim 7, further comprising:
obtaining, by the interactive credential provider, cloud directory credentials for the cloud directory authority, wherein the cloud directory authority provides the remote session access token, the pseudo-client cloud directory nonce, and the server cloud directory nonce in response to validating the cloud directory credentials.

9. The method of claim 8, wherein obtaining the cloud directory credentials includes obtaining user credentials from a multi-factor authentication (MFA) device connected to the client device.

10. The method of claim 9, wherein obtaining the cloud directory credentials comprises, obtaining, via the remote display protocol connection and using a virtual channel protocol, the cloud directory credentials.

11. The method of claim 9, wherein obtaining the cloud directory credentials comprises performing a reverse seamless authentication process with the client device, wherein the reverse authentication process comprises:
routing, via the remote display protocol connection and to the client device, a request for the cloud directory credentials.

12. The method of claim 7, wherein performing the login to the remote session is based on validation of the credentials blob.

13. A computing system comprising:
one or more processors;
memory storing computer executable instructions that, when executed by the processor, cause the computing system to:
instantiate, at the computing system, an interactive credential provider;
receive, from a client device, a notification of a remote display protocol connection;
execute, based on the notification of the remote display protocol connection, by the interactive credential provider, and with a cloud directory authority, a single sign on (SSO) protocol, wherein the SSO protocol is configured for use between the client device and the remote desktop server; and
perform, based on successful execution of the SSO protocol and for the client device, a login to a remote session between the client device and the computing system.

14. The computing system of claim 13, wherein the memory stores additional computer executable instructions that, when executed by the one or more processors, cause the computing system to:
detect session lock for the remote session;
instantiate the interactive credential provider;
receive, by the interactive credential provider, selection of a session unlock interface element;
execute, based on the selection of the session unlock interface element, by the interactive credential provider, and with the cloud directory authority, the SSO protocol; and
unlock, based on successful execution of the SSO protocol and for the client device, the remote session.

15. The computing system of claim 13, wherein the memory stores additional computer executable instructions that, when executed by the one or more processors, cause the computing system to:
generate, by the interactive credential provider, a public-private keypair, wherein executing, the SSO protocol comprises executing, using the public-private keypair, the SSO protocol.

16. The computing system of claim 15, wherein instantiating the interactive credential provider generates the public-private keypair, and wherein the public-private keypair comprises a Rivest-Shamir-Adleman public-private keypair.

17. The computing system of claim 13, wherein the notification of the remote display protocol connection includes a username hint for a user of the client device.

18. The computing system of claim 13, wherein the interactive credential provider generates a session login interface element, and wherein executing the SSO protocol is in response to receiving selection of the session login interface element.

19. The computing system of claim 13, wherein executing the SSO protocol comprises:
creating, by the interactive credential provider, a correlation identifier;
requesting, using the correlation identifier, by the interactive credential provider, and from the cloud directory authority, a remote session access token, a pseudo-client cloud directory nonce, and a server cloud directory nonce;
receiving, from the cloud directory authority, the remote session access token, the pseudo-client cloud directory nonce, and the server cloud directory nonce;
creating, by the interactive credential provider, a remote desktop protocol (RDP) assertion, wherein the RDP assertion is created based on a public key of the public-private keypair, a device identifier of the cloud directory authority, the remote session access token, the pseudo-client cloud directory nonce, and the server cloud directory nonce;
signing, by the interactive credential provider, the RDP assertion;
generating a request, by the interactive credential provider, for a credentials blob from the cloud directory authority, wherein the request includes the RDP assertion and the correlation identifier; and
receiving, from the cloud directory authority, the credentials blob in response to the request.

20. One or more non-transitory computer-readable media storing instructions that, when executed by a computing system comprising at least one processor, a communication interface, and memory, cause the computing system to:
instantiate, at the computing system, an interactive credential provider;
receive, from a client device, a notification of a remote display protocol connection;
execute, based on the notification of the remote display protocol connection, by the interactive credential provider, and with a cloud directory authority, a single sign on (SSO) protocol, wherein the SSO protocol is configured for use between the client device and the remote desktop server; and
perform, based on successful execution of the SSO protocol and for the client device, a login to a remote session between the client device and the computing system.
